(19) United States
(12) Patent Application Publication
(10) Pub. No.: US 2026/0300774 A1
(43) Pub. Date: Oct. 1, 2026

(54) Sentiment And Alignment Scoring As A Proxy For Explicit User Feedback In Conversational Artificial Intelligence Systems

(71) Applicant: Oracle International Corporation, Redwood Shores, CA (US)

(72) Inventors: Priyaranjan Pattnayak, Snohomish, WA (US); Amit Agarwal, Seattle, WA (US); Hansa Meghwani, Bengaluru (IN)

(73) Assignee: Oracle International Corporation, Redwood Shores, CA (US)

(21) Appl. No.: 19/091,775

(22) Filed: Mar. 26, 2025

(51) Int. Cl. G06N 5/04

(52) U.S. Cl. CPC G06N 5/04

(57) ABSTRACT

Artificial intelligence chatbot performance is improved through automated conversation quality analysis and training example generation. Chatbot conversations are processed via dual pathways, a sentiment analysis model measuring user satisfaction and an alignment analysis model evaluating query-answer semantic correspondence. These analyses produce alignment and sentiment scores that are combined into a sentiment and alignment deviation composite score called a “SADI score.” The SADI score quantifies response accuracy and satisfaction changes across conversation segments, enabling identification of problematic patterns. When SADI scores indicate significant deviations from performance thresholds, the new training examples are generated from the problematic conversations. The generated examples focus on segments showing sentiment or alignment degradation. A target machine learning model receives parameter updates using these examples, creating a feedback loop where user interactions drive model refinement. The systematic approach enables chatbot adaptation based on real interactions while addressing manual analysis limitations and implicit feedback incorporation.

### TECHNICAL FIELD

This disclosure relates generally to artificial intelligence. More particularly, this disclosure relates to conversational artificial intelligence systems.

### BACKGROUND

End users interacting with generative artificial intelligence (AI) chatbots seeking support experience frustration due to inaccurate responses and fragmented documentation. The existence of siloed and duplicate content compounds these issues, resulting in inconsistent answers. Users signal dissatisfaction through specific behaviors-conversation abandonment, support escalations, and unresolved queries. Sentiment variations during multi-turn conversations provide valuable performance indicators though current systems lack mechanisms to capture and analyze these signals.

The absence of automated systems for converting implicit user feedback and behavioral data into training datasets prevents machine learning model improvements based on real-world interactions. Manual analysis of large-scale interaction data and documentation presents significant operational challenges. The lack of an automated framework for processing feedback (both explicit and implicit), prioritizing customer issues, and extracting usage patterns creates bottlenecks in model improvement cycles. These limitations impact the capability to deliver efficient customer support and maintain competitive advantages in services marketplaces such as cloud services where generative AI chatbots are used to support end-users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system and method for analyzing query-answer pairs from an AI chatbot conversation to generate training examples based on sentiment and alignment scores in accordance with one or more embodiments;

FIG. 2 illustrates a system and method for calculating a contextual contrast score by applying temporal weights to sentiment scores from sequential query-answer pairs in a chatbot conversation in accordance with one or more embodiments;

FIG. 3 illustrates a system and method for converting a sentiment score into a hard label and calculating a composite score using alignment scores and the converted label in accordance with one or more embodiments;

FIG. 4 illustrates a system and method for determining an alignment score by analyzing query complexity, evaluating expected detail levels, and comparing them with actual answer detail levels in accordance with one or more embodiments;

FIG. 5 illustrates a system and method for calculating a sentiment and alignment deviation composite score by processing sentiment labels and alignment scores through multiple computational blocks in accordance with one or more embodiments;

FIG. 6 illustrates a system of a chatbot conversation timeline showing identification and isolation of a negative context window where conversation quality transitions from positive to negative in accordance with one or more embodiments;

FIG. 7 illustrates a system and method for extracting topic clusters and determining question type classifications from chatbot conversations and storing these classifications as associated metadata in accordance with one or more embodiments;

FIG. 8 illustrates a method for generating training examples through Retrieval Augmented Generation (RAG) document analysis, batch simulation, and comparative metric evaluation for machine learning model improvement in accordance with one or more embodiments;

FIG. 9 illustrates a system of alternative target machine learning model types, including a document reranker model, a document embedding model, a large language model (LLM), and an aggregator model that receive training examples in accordance with one or more embodiments;

FIG. 10 illustrates an example transformer architecture that may be used in the implementation of an LLM according to one or more embodiments; and

FIG. 11 illustrates an example computer system for use in an implementation of sentiment and alignment scoring as a proxy for user feedback in conversational AI systems in accordance with one or more embodiments.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In some embodiments, well-known structures and devices are shown in the figures in block diagram form to avoid unnecessarily obscuring the embodiment.
1. GENERAL OVERVIEW
2. SENTIMENT AND ALIGNMENT SCORING AS A PROXY FOR EXPLICIT USER FEEDBACK IN CONVERSATIONAL AI SYSTEMS
   2.1. CONTEXTUAL CONTRAST SCORE CALCULATION
   2.2. CONVERTING A SENTIMENT SCORE INTO A HARD LABEL
   2.3. DETERMINING AN ALIGNMENT SCORE BY ANALYZING QUERY COMPLEXITY
   2.4. CALCULATING A SENTIMENT AND ALIGNMENT DEVIATION COMPOSITE SCORE
   2.5. NEGATIVE CONTEXT WINDOW
   2.6. EXTRACTING TOPIC AND QUESTION-TYPE CLASSIFICATIONS
   2.7. GENERATING TRAINING EXAMPLES THROUGH RAG DOCUMENT ANALYSIS
   2.8. TARGET MACHINE LEARNING MODEL
3. EXAMPLE EMBODIMENT
4. PRACTICAL APPLICATIONS; ADVANTAGES; IMPROVEMENTS
5. EXAMPLE LLM ARCHITECTURE
6. COMPUTER NETWORKS AND CLOUD NETWORKS
7. HARDWARE OVERVIEW
8. MISCELLANEOUS; EXTENSIONS

### 1. GENERAL OVERVIEW

One or more embodiments address the challenge of improving artificial intelligence (AI) chatbot performance by analyzing conversation quality and generating targeted training examples. The embodiment processes query-answer pairs sequentially through two analytical pathways. The first pathway employs an alignment analysis model to evaluate the semantic correspondence between queries and their respective answers. For a query-answer pair, the model generates an alignment score (sometimes referred to as a “reward score”) quantifying how well the answer addresses the specific query content. The second pathway utilizes a sentiment analysis model to measure user satisfaction, producing two types of sentiment scores: a pairwise sentiment score for the immediate query-answer interaction, and a contextual sentiment score that encompasses all query-answer pairs up to that point in the conversation. The contextual sentiment score introduces a lag that prevents the model from being overly reactive to momentary fluctuations.

By combining alignment scores from consecutive query-answer pairs with sentiment scores, the embodiment calculates a composite metric called the sentiment and alignment deviation composite index (SADI), that is sometimes called “the sentiment and alignment deviation composite score” or just “SADI score”. This score captures both the technical accuracy of responses and changes in user satisfaction across conversation segments. The composite scoring mechanism provides a quantitative basis for identifying problematic conversation patterns where response quality degrades, or user sentiment deteriorates.

The embodiment then leverages these composite scores to automatically identify conversation segments that warrant model improvement. When the composite score indicates a change from positive to negative values, the embodiment marks the conversation as requiring attention, provided there is a minimum of three turns in each conversation to ensure data coverage and stability. When these conditions are met, the embodiment generates new training examples derived from the problematic query-answer pairs, focusing particularly on segments where alignment scores or sentiment metrics show degradation.

The embodiment updates the parameters of a target machine learning model using the generated training examples. This creates a feedback loop where real-world user interactions drive continuous model refinement. The nature of training example generation addresses the manual analysis bottleneck, while the dual consideration of alignment and sentiment ensures that both technical accuracy and user satisfaction influence model updates.

Through this systematic approach, the embodiment enables the chatbot to adapt based on actual user interactions, specifically targeting scenarios where response quality or user satisfaction decline. The embodiment directly addresses the background problems of manual analysis limitations, siloed content issues, and the need to capture implicit user feedback signals for model improvement.

One or more embodiments described in this Specification and/or recited in the claims may not be included in the General Overview section.

One or more embodiments will now be described with respect to the figures. In one or more embodiments, a system depicted in a figure may include more or fewer components than the components illustrated in the figure. The components illustrated in the figure may be local to or remote from each other. The components illustrated in the figure may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in Section 6, titled “Computer Networks and Cloud Networks.” In one or more embodiments, one or more operations of method illustrated in a figure may be modified, rearranged, or omitted all together. Accordingly, the particular sequence of operations illustrated in a figure should not be construed as limiting the scope of one or more embodiments.

### 2.0 Sentiment and Alignment Scoring as a Proxy for Explicit User Feedback in Conversational AI Systems

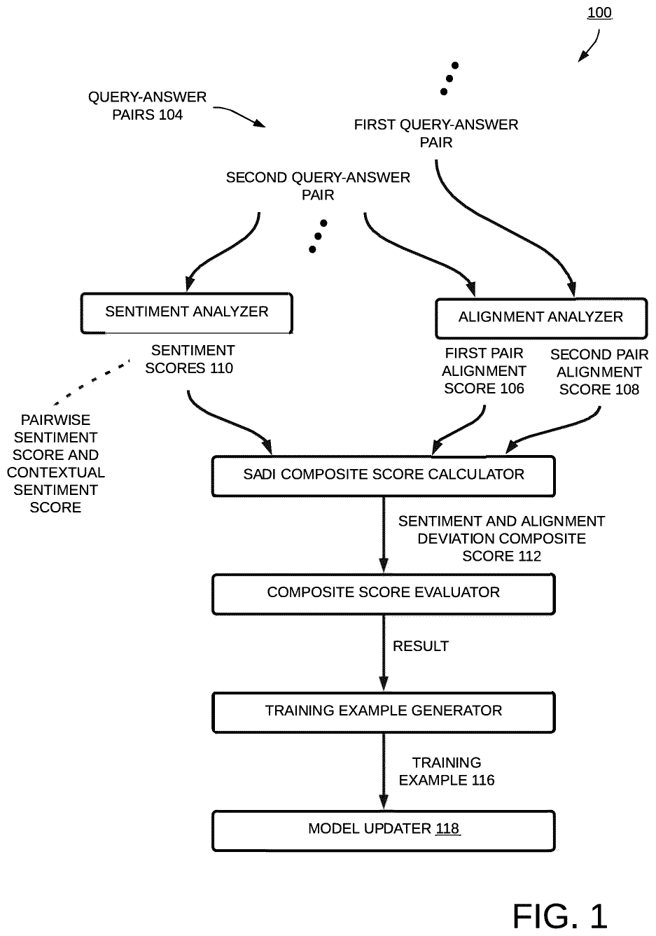

FIG. 1 illustrates a system and method 100 for analyzing query-answer pairs 104 from an AI chatbot conversation to generate training examples (e.g., 116) based on pairwise sentiment scores, contextual sentiment scores, and alignment scores (e.g., 106, 108, 110) in accordance with one or more embodiments.

The system and method 100 processes query-answer pairs 104 from a chatbot conversation by evaluating sequential interactions. An alignment analysis model examines the first query-answer pair to generate an alignment score 106 measuring how well the answer matches the query. The same alignment analysis process occurs for the second query-answer pair in the conversation sequence. A sentiment analysis model then analyzes the second query-answer pair to determine a sentiment score 110 representing the emotional tone or attitude of the interaction. The system and method 100 calculates a composite score 112 combining both sentiment and alignment metrics 106, 108, and 110 to assess changes in conversation quality between the sequential pairs. When the composite score 112 indicates notable patterns or deviations for three or more consecutive turns, the system and method 100 generates a training example 116 based on the second query-answer pair. The training example 116 serves to update parameters of a target machine learning model, enabling continuous improvement of the chatbot's performance. This approach allows for automated quality monitoring and enhancement of AI chatbot conversations through data-driven feedback loops.

The system and method 100 involves obtaining sequential pairs 104 of user queries and chatbot responses from a conversation session. A query-answer pair includes a user's question or input and the corresponding response generated by the AI chatbot. The query-answer pairs 104 serve as the data units for analyzing conversation quality and effectiveness. These pairs undergo multiple types of analysis, including sentiment analysis and alignment scoring. The system and method 100 processes these pairs both individually and in sequence to evaluate the progression of conversation quality, with sentiment being analyzed both at the pairwise level and the contextual level, while alignment scores remain pairwise. The pairs 104 are structured chronologically, allowing the system and method 100 to track changes between consecutive interactions. The first query-answer pair and the second query-answer pair of the system and method 100 represent two consecutive query-answer pairs of the query-answer pairs 104 in chronological order. For example, the system and method 100 analyzes how well the chatbot's answers align with user queries and how user sentiment evolves from one exchange to the next, capturing both immediate reactions and overall conversation satisfaction. These pairs 104 can include various types of interactions, including instructional queries, troubleshooting requests, and general guidance queries. The query-answer pairs 104 form the foundation for calculating various metrics, such as pairwise sentiment scores, contextual sentiment scores, alignment scores, and deviation indices. The system and method 100 uses these pairs 104 to identify transitions in conversation quality and user satisfaction, particularly through the SADI calculations. Receiving the query-answer pairs 104 initiates the analysis pipeline, enabling subsequent processing steps that evaluate conversation quality, generate training data, and improve the AI system's performance over time.

The system and method 100 evaluates how well a chatbot's answer aligns with the user's query in the first query-answer pair of a conversation. The alignment score calculation uses an alignment analysis model to assess the appropriateness and relevance of the chatbot's response to the specific query presented. This score reflects the degree of coherence between the question asked and the answer provided. The alignment score measures multiple aspects of the response quality. For simple questions requiring brief answers, the alignment score favors concise, direct responses. For complex questions requiring detailed explanations, the alignment score rewards comprehensive, step-by-step responses. The scoring system penalizes both overly verbose responses to simple questions and oversimplified responses to complex questions. The alignment score operates at the individual message pair level, generating a quantitative measure that indicates how accurately and appropriately the chatbot addresses the user's specific query. This scoring considers the inherent context and complexity of a query to determine the appropriate level of detail expected in the response. The score serves as an input for calculating the broader SADI score, that tracks changes in conversation quality across multiple query-answer pairs.

The system and method 100 evaluates query-answer pair alignment within a generative AI chatbot conversation. The alignment score calculation specifically measures how well the chatbot's answer aligns with and appropriately addresses the user's query in the second query-answer pair of the conversation. This alignment scoring process evaluates the quality and contextual appropriateness of the chatbot's response. The scoring mechanism adapts to the complexity of the query, rewarding concise responses for simple questions and detailed explanations for complex queries. The alignment score reflects how accurately and appropriately the chatbot resolves the specific user query within that pair. The score considers several factors, such as response completeness, relevance, and appropriate level of detail, based on the query's inherent context and complexity. This alignment score becomes a component in calculating the overall SADI score that measures conversation quality changes between consecutive interactions.

The system and method 100 analyzes and calculates a sentiment score for the second query-answer pair in a generative AI chatbot conversation. The sentiment score is determined using a sentiment analysis model that evaluates the emotional tone and user satisfaction level expressed within the second query-answer exchange. The sentiment score ranges from −1 to +1. The system and method 100 converts these decimal scores to hard labels, where-1 represents negative sentiment, 0 represents neutral sentiment, and +1 represents positive sentiment. The raw decimal scores are stored as metadata for downstream processing. The sentiment analysis operates at both a granular and contextual/cumulative level, focusing specifically on individual query-answer message pairs and focusing on all query-answering message pairs up and until each turn to calculate contextual similarity score. The sentiment score reflects the user's emotional state and satisfaction during that specific and until the interaction (including the current turn) in the conversation. The system and method 100 uses this granular analysis to determine the effectiveness of specific chatbot responses and documentation. The sentiment score for the second query-answer pair serves as a component in calculating the broader SADI score. This composite score helps evaluate changes in conversation quality and aids in identifying sections of conversations that require improvement or can serve as examples for model training. The sentiment analysis is part of a larger system that combines both sentiment and alignment metrics to provide comprehensive conversation quality assessment. The system and method 100 stores these scores for visualization through business intelligence dashboards and uses them for model fine-tuning purposes.

The system and method 100 evaluates the quality and progression of a chatbot conversation by combining multiple metrics. The system and method 100 calculates a composite score that reflects changes in conversation quality between consecutive query-answer pairs. The component processes two metrics, alignment scores and sentiment scores. The alignment scores measure how well the chatbot's answers match their corresponding queries, evaluating response appropriateness and accuracy. The sentiment scores assess the emotional tone of the interactions, ranging from negative (−1) to positive (+1). The calculation specifically examines the relationship between consecutive query-answer pairs. It considers the alignment score of a first query-answer pair then compares it with both the alignment score and sentiment score of the subsequent query-answer pair. This sequential analysis helps detect transitions or stability in conversation quality. The composite score serves as a quantitative measure of conversation progression, identifying whether the interaction deteriorated, remained stable, or improved. The score is particularly valuable for identifying sections of conversations where quality changes occur, that can be used to generate training examples for improving the chatbot's performance.

The system and method 100 uses these scores to identify conversation segments for model training and improvement. The scores help isolate specific portions of conversations where sentiment shifts occur. There is a decision point in the system and method 100 where the system and method 100 determines whether or not to create a training example based on the calculated SADI score 112. This determination is made after analyzing consecutive query-answer pairs in a chatbot conversation for both alignment and sentiment changes. The decision to generate a training example is based on the SADI score 112, that combines multiple metrics, the alignment scores from consecutive query-answer pairs and the sentiment score of the second pair. Additionally, the system implements an optional extra filtering step to filter out negative context conversations that have less than 3 query-answer pairs, ensuring sufficient data for reliable analysis. This composite score indicates whether the conversation quality degraded, remained stable, or improved between the analyzed pairs.

The system and method 100 utilizes both direct user feedback and conversation context for creating training data. The system and method 100 specifically targets conversations showing sentiment shifts as valuable training samples for model alignment. These training examples are particularly useful for fine-tuning LLMs and improving their performance based on real-world interactions. The determination process helps identify meaningful training examples that can contribute to model improvement, especially in cases where the conversation shows significant changes in quality or user satisfaction. This selective approach ensures that the generated training examples are particularly valuable for improving the model's handling of similar situations in future interactions.

The system and method 100 creates training data from a query-answer pair within a chatbot conversation after determining the conversation quality has changed. The generation occurs specifically when a SADI score indicates a significant shift in conversation quality between consecutive query-answer pairs. The training example generation process analyzes both alignment scores and sentiment scores from consecutive message pairs. The alignment scores measure how well chatbot responses match their corresponding queries. The sentiment scores indicate the emotional tone or satisfaction level detected in the interaction. When these metrics show notable changes between consecutive exchanges, the system and method 100 flags the conversation segment for training data creation. The training example is derived from the second query-answer pair in the sequence, with an optional condition: only if the query-answer pair count is 3 or more in the flagged conversation. This approach captures specific instances where conversation quality shifted, providing focused training data that helps the model learn from both successful and problematic interactions. The generated training examples are used to update the parameters of target machine learning models, enabling continuous improvement based on real-world conversation patterns. The process is particularly valuable for improving model performance in handling conversation transitions and maintaining consistent response quality. The training examples help models learn to prevent negative sentiment shifts and maintain positive user experiences throughout conversations.

The system and method 100 modifies the parameters of a target machine learning model using generated training examples. The parameters are updated based on training examples derived from query-answer pairs that exhibit significant sentiment and alignment deviation patterns. The update process specifically targets model parameters that influence how the model responds to user queries, incorporating insights from real conversation dynamics and user feedback. This parameter updating mechanism serves as a component in the continuous learning and adaptation of the AI system, ensuring the model evolves based on actual user interactions and conversation quality metrics. The update process is focused on improving model performance in areas where sentiment and alignment scores indicate suboptimal chatbot responses or user dissatisfaction. This updating process is part of a larger feedback loop that interconnects user interactions, document retrieval, and LLM fine-tuning to ensure continuous optimization while preventing concept drift or data drift that could lead to performance degradation.

### 2.1 Contextual Contrast Score Calculation

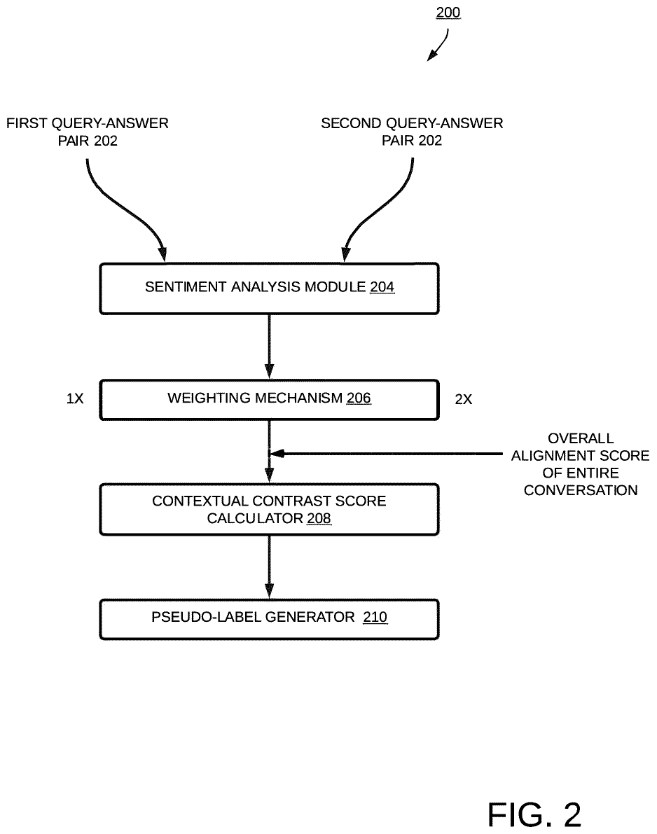

FIG. 2 illustrates a system and method 200 for calculating a contextual contrast score by applying temporal weights to sentiment scores from sequential query-answer pairs in a chatbot conversation in accordance with one or more embodiments.

The system and method 200 extends the system and method 100 of FIG. 1 by incorporating sentiment scoring for both first and second query-answer pairs using a sentiment analysis model 204. A temporal weighting mechanism 206 applies different weights to the sentiment scores based on chronological position in the conversation with greater weight assigned to the more recent second query-answer pair. This gives the weighted sentiment score of the entire conversation. This score is then multiplied with the overall alignment score of the entire conversation to create the contextual contrast score 208, capturing the temporal evolution of sentiment throughout the conversation. Based on this contextual contrast score, the system and method 200 generates a pseudo-label 210 for the entire chatbot conversation. The weighting mechanism 206 emphasizes recent interactions over earlier ones, allowing the system and method 200 to reflect the current state and progression of the conversation quality. This temporal-aware analysis provides additional context beyond the SADI scoring of the embodiment of FIG. 1.

The query-answer pairs 202 represent sequential interactions between a user and a generative AI chatbot within a conversation. These pairs are units of analysis that include of a user's query and the chatbot's corresponding answer. These pairs are analyzed for both sentiment and alignment characteristics. Additionally for sentiment, all query-answer pairs until (and including) the current turn are used. The query-answer pairs 202 serve as input for multiple analytical processes. A pair and the current query-answer pair along with previous query-answer pairs undergo sentiment analysis to determine the emotional tone of the interaction, with scores ranging from negative to positive. The pairs also receive alignment scores that measure how well the chatbot's answer addresses the user's query.

The system and method 200 processes these pairs sequentially, with attention given to their temporal relationship. The second query-answer pair receives greater weight in sentiment calculations than the first pair, reflecting the system and method 200's emphasis on more recent interactions. This weighted approach helps capture the evolution of conversation quality over time. The query-answer pairs 202 contribute to the calculation of multiple metrics, including a SADI score and a contextual contrast score. The contextual contrast score considers alignment score multiplied by sentiment score, where the alignment score equals the alignment score. These scores help evaluate conversation quality and generate pseudo-labels for training purposes. The pairs serve as the foundational data structure for tracking changes in conversation quality and user satisfaction throughout the interaction. These pairs enable the system to analyze conversations at a granular level, supporting both immediate quality assessment and longer-term model improvement through training example generation. The structured nature of these pairs allows for systematic evaluation of chatbot performance and user experience across multiple dimensions of analysis.

The sentiment analysis module 204 is a component that performs sentiment analysis on query-answer pairs within generative AI chatbot conversations. The module evaluates the emotional tone and user satisfaction level for a interaction pair, generating sentiment scores ranging from −1 (negative) to +1 (positive). The sentiment analysis module 204 processes both individual query-answer pairs as well as contextual (all available query-answer pairs in the conversation) until the given turn and contributes to overall conversation analysis. For temporal weighting purposes, the module assigns different weights to sentiment scores based on the chronological position of query-answer pairs within the conversation. More recent interactions receive higher weights than earlier interactions with the second query-answer pair receiving greater weight than the first query-answer pair. The module's sentiment scores are used in conjunction with alignment scores to calculate contextual contrast scores for conversations (not depicted in FIG. 2). These scores help determine the conversation's overall quality and user satisfaction level. The sentiment scores generated by the module also enable the creation of pseudo-labels when explicit user feedback is unavailable. The sentiment analysis module 204 operates as part of the system and method 200 that processes chat conversations through multiple analytical pipelines. The module's sentiment analysis capabilities support the calculation of SADI scores, that reflect changes in conversation quality between sequential query-answer pairs. These composite scores help identify conversations suitable for generating training examples to improve the target machine learning model.

The weighting mechanism 206 is a component that applies differential weights to sentiment scores based on the temporal position of query-answer pairs within a generative AI chatbot conversation. The weighting mechanism assigns higher weights to more recent interactions, specifically giving greater weight to sentiment scores from later query-answer pairs compared to earlier ones in the conversation sequence. This temporal weighting reflects the principle that recent interactions have more significance in determining the overall conversation quality and user satisfaction. The weighting mechanism 206 operates by analyzing sentiment scores derived from a sentiment analysis model for different query-answer pairs. For sequential pairs of interactions, the mechanism applies a higher weight coefficient to the later pair's sentiment score compared to the earlier pair's score. This weighted calculation contributes to computing overall weighted sentiment score which is then multiplied with overall alignment score of the conversation to create the contextual contrast score that evaluates the overall conversation quality. The mechanism's output influences the generation of pseudo-labels for conversations. These pseudo-labels serve as automated indicators of conversation quality when explicit user feedback is unavailable. The weighted sentiment scores provide a more temporally aware representation of the conversation's progression and ultimate outcome. The weighting approach aligns with the system and method 200's focus on capturing evolving conversation dynamics and quality, particularly in identifying transitions between positive and negative user experiences. This temporal weighting helps prevent earlier sentiment signals from overshadowing more recent and potentially more relevant user reactions in the conversation flow.

The contextual contrast score calculator 208 is a component that evaluates the overall quality and progression of generative AI chatbot conversations. The calculator processes sentiment scores from multiple query-answer pairs while applying temporal weighting to emphasize more recent interactions. The calculator assigns different weights to sentiment scores based on their chronological position in the conversation. More recent query-answer pairs receive higher weights than earlier pairs. Specifically, when analyzing two consecutive pairs, the second (more recent) query-answer pair's sentiment score receives a higher weight than the first pair's score. The contextual contrast score calculator 208 combines these weighted sentiment scores and alignment score to generate a comprehensive contextual contrast score for the conversation. This score helps determine the conversation's effectiveness by considering how user sentiment evolves over time. The calculator uses this score to generate pseudo-labels that can be used for training and evaluation purposes. The calculator's weighting mechanism reflects the understanding that recent interactions have more significance in determining the conversation's ultimate success or failure. This temporal weighting approach provides a more nuanced view of conversation quality compared to simple averaging of sentiment scores. The contextual contrast score serves as a metric for evaluating chatbot performance and generating training data to improve the system.

The pseudo-label generator 210 is a component that creates automated labels for chatbot conversations based on temporal sentiment analysis and weighted scoring mechanisms. The generator analyzes query-answer pairs within a conversation by applying different weights to sentiment scores based on their chronological position with more recent interactions receiving higher weights. For example, when analyzing two consecutive query-answer pairs, the second (more recent) pair's sentiment score receives a greater weight than the first pair's score in calculations. The pseudo-label generator 210 calculates a contextual contrast score that incorporates these weighted sentiment scores and alignment score into evaluate the overall conversation quality. This score reflects how user sentiment evolves throughout the interaction while emphasizing recent exchanges. The generator uses this contextual contrast score to automatically assign a classification label to the conversation. The generator's functionality addresses the challenge of limited explicit user feedback. By generating pseudo-labels through weighted sentiment analysis, the system and method 200 can evaluate and categorize conversations even without explicit user feedback using the sentiment scoring system's granular analysis capabilities and the weighted approach prioritizing recent messages. The pseudo-label generator 210 serves as part of the larger training data creation pipeline, helping to improve the chatbot's performance by providing automated conversation classifications based on temporal sentiment patterns and contextual analysis.

### 2.2 Converting a Sentiment Score into a Hard Label

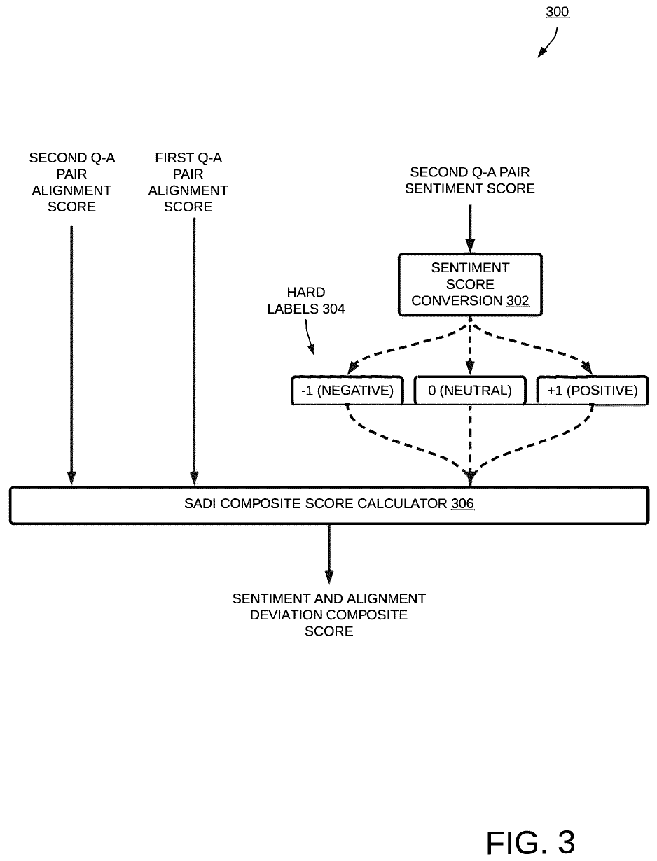

FIG. 3 illustrates a system and method 300 for converting a sentiment score into a hard label (e.g., −1, 0, or +1) and calculating a composite score using alignment scores and the converted label in accordance with one or more embodiments.

The system and method 300 extends the sentiment analysis of the system and method 100 of FIG. 1 by implementing a classification scheme that maps sentiment scores to three distinct numerical values. The sentiment scores for query-answer pairs are transformed into hard labels, where negative sentiments are assigned a value of −1, neutral sentiments receive a value of 0, and positive sentiments are given a value of +1. This discrete categorization system applies to both the pairwise sentiment scores for immediate query-answer interactions and the contextual sentiment scores that encompass all query-answer pairs up to and including the current conversation turn. This dual sentiment analysis approach standardizes sentiment evaluation across the conversation analysis, enabling more robust interpretation and processing of emotional content within the chatbot interactions. The resulting hard labels are then incorporated into the broader composite score calculation described in the system and method 100 of FIG. 1, that evaluates changes in conversation quality across sequential query-answer pairs.

The sentiment score conversion component 302 is a processing module that transforms continuous sentiment scores into discrete categorical labels for query-answer pairs in chatbot conversations. The component converts decimal sentiment scores ranging from −1 to +1 into three distinct hard labels: negative (−1), neutral (0), and positive (+1). This conversion process standardizes sentiment measurements for downstream calculations of the SADI score. The component operates within the context of analyzing sequential query-answer pairs in generative AI chatbot conversations. The conversion specifically processes sentiment scores that reflect the emotional tone and satisfaction level detected in user interactions. These hard labels provide a simplified representation of user sentiment that can be effectively combined with alignment scores to evaluate conversation quality changes. The sentiment score conversion component 302 serves as a preprocessing step that enables the system to quantify sentiment shifts between consecutive query-answer pairs. By converting continuous sentiment values to discrete labels, the component facilitates operations that combine sentiment and alignment metrics to assess effectiveness of the conversation. This standardization is useful for generating training examples that help improve the target machine learning model's performance. The component's output influences the calculation of SADI scores, that measure changes in conversation quality across sequential interactions. These discrete sentiment labels, when combined with alignment scores, provide clear indicators of conversation effectiveness and help identify sections requiring model improvements.

The hard labels 304 represent a discrete categorization system for sentiment scores in chatbot conversations. These labels include three specific values: −1 (negative), 0 (neutral), and +1 (positive). The system and method 300 converts continuous sentiment scores from query-answer pairs into these discrete values for more standardized processing and analysis. The hard labels serve as a simplified representation of user sentiment in the conversation. The conversion from continuous sentiment scores to these three discrete values enables clearer classification of user reactions and facilitates the calculation of the SADI score. The negative label (−1) indicates clear user dissatisfaction or negative sentiment. The neutral label (0) represents neither positive nor negative sentiment. The positive label (+1) signifies user satisfaction or positive sentiment. These hard labels are used when analyzing the second query-answer pair in a conversation sequence. The system and method 300 applies these labels as part of calculating the overall SADI score. The discrete nature of these labels helps standardize the measurement of sentiment changes across different parts of the conversation. The hard labels contribute to a more structured approach in evaluating conversation quality and generating training examples for improving the chatbot's performance. This labeling system aligns with the broader goal of capturing and quantifying user satisfaction patterns in chatbot interactions.

The calculation component 306 is a processing module that performs sentiment score conversion and composite score computation for analyzing chatbot conversation quality. The component converts continuous sentiment scores into discrete hard labels with specific numerical values: −1 for negative sentiment, 0 for neutral sentiment, and +1 for positive sentiment. These hard labels provide a standardized way to quantify user sentiment in chatbot interactions. The calculation component 306 uses these hard labels along with the absolute values of alignment score deviations between consecutive turns to compute a SADI score. This composite score evaluates changes in conversation quality between sequential query-answer pairs. The component analyzes both the alignment between questions and answers as well as the user's emotional response captured through sentiment analysis. The component implements a weighted scoring approach where the SADI is calculated by multiplying the delta of alignment scores between each turn (the deviation score) with sentiment label values. This calculation helps quantify how helpful and satisfying the conversation was for users. The component processes both individual message pairs and entire conversation segments to generate these composite quality metrics. The calculation component 306 serves as an element in the system and method 300 for evaluating chatbot performance and generating training data. Through standardized label conversion and composite score calculation, this component enables systematic analysis of conversation quality changes and helps identify areas needing improvement in the chatbot's responses.

### 2.3 Determining an Alignment Score by Analyzing Query Complexity

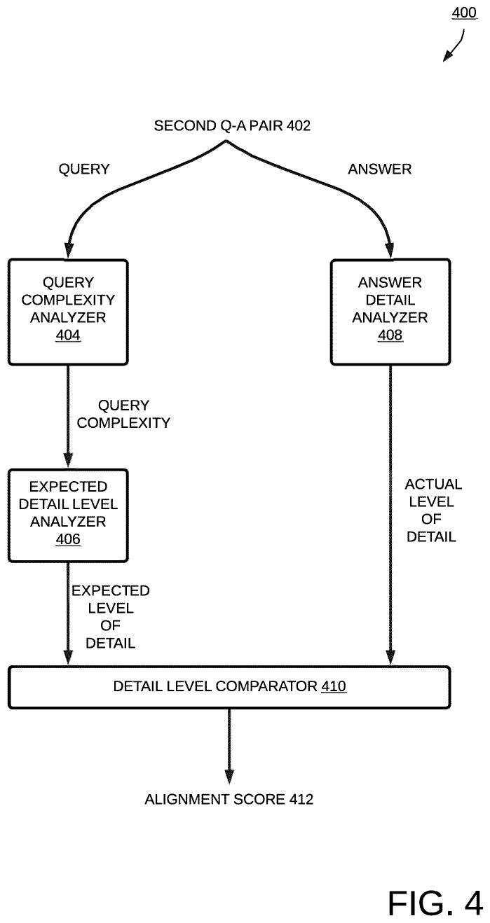

FIG. 4 illustrates a system and method 400 for determining an alignment score by analyzing query complexity, evaluating expected detail levels, and comparing them with actual answer detail levels in accordance with one or more embodiments.

The system and method 400 extends the alignment scoring process of the system and method 100 of FIG. 1 for the second query-answer pair 402 by first analyzing the complexity level of the query component. Based on this complexity assessment, the system and method 400 determines an expected level of detail that should be present in the corresponding answer. The alignment score calculation then incorporates a comparison between the actual level of detail provided in the answer and the expected level of detail derived from the query complexity. This alignment scoring mechanism provides an evaluation of query-answer pairs by considering if the answer's detail level appropriately matches the complexity of the query. The system and method 400 builds upon the alignment analysis of the system and method 100 of FIG. 1 by adding complexity-based expectations to the scoring criteria, resulting in accurate assessments of conversation quality within the generative AI chatbot system.

The query from second query-answer pair 402 refers to a user's question or input that appears in the second sequential exchange between a user and a generative AI chatbot. This query is specifically analyzed for its complexity level to determine the appropriate level of detail expected in the chatbot's response. The system 400 evaluates queries contextually, distinguishing between simple questions requiring brief answers and complex questions needing detailed explanations. The query serves as an input for the alignment scoring system, that assesses if the chatbot's response matches the appropriate level of detail based on the query's complexity. For example, a simple query like asking for a capital city would expect a concise response, while a complex query about implementing technical procedures would require comprehensive, step-by-step instructions. The query's complexity directly influences how the system and method 400 evaluates the alignment between the question and answer with penalties applied for responses that are either too verbose for simple queries or too simplified for complex ones.

The query complexity analyzer 404 is a component that evaluates the intricacy and depth of user queries within chatbot conversations. The analyzer determines a complexity level for queries by assessing various factors, such as the query's structure, content requirements, and technical depth. This complexity assessment directly influences how the system and method 400 evaluates response appropriateness. The analyzer works in conjunction with alignment scoring by establishing expectations for response detail. For simple queries requiring brief answers, the analyzer sets lower-detailed level expectations. For complex queries requiring comprehensive explanations, the analyzer sets higher-detailed level expectations. These expectations serve as benchmarks for evaluating response alignment. The query complexity analyzer 404 enables context-aware evaluation of chatbot responses. The analyzer helps distinguish between scenarios requiring concise answers (e.g., “What is the capital of France?”) versus those needing detailed explanations (e.g., “How do I implement a VLOOKUP in Excel?”). The system and method 400 uses these distinctions to appropriately score response alignment by penalizing both overly verbose responses to simple questions and oversimplified responses to complex questions. The analyzer contributes to the overall alignment scoring process by providing a framework for comparing actual response detail levels against expected detail levels based on query complexity. This comparison helps determine if the chatbot's responses are appropriately calibrated to user query requirements, supporting accurate alignment score calculation for query-answer pairs.

The expected detail level evaluator 406 is a component that assesses the appropriate level of detail required in chatbot responses based on query complexity. This evaluator operates as part of the alignment scoring system to ensure responses are contextually appropriate in terms of their detail level. The evaluator first analyzes incoming queries to determine their complexity level. For simple, straightforward queries (e.g., “What is the capital of France?”), the evaluator sets expectations for concise, direct responses. For complex queries, such as detailed technical troubleshooting requests, the evaluator establishes expectations for comprehensive, step-by-step responses. The expected detail level evaluator 406 then compares the actual response detail level against these expectations. The evaluator penalizes responses that are either overly verbose for simple queries or oversimplified for complex queries. This comparison contributes to the alignment score calculation for query-answer pairs. The evaluator works in conjunction with the alignment scoring system to generate scores ranging from −1 to +1, reflecting how well the response detail matches the query's complexity requirements. These scores become part of the broader SADI score calculation used for evaluating conversation quality and generating training examples. This component supports the system and method 400's context-aware learning capabilities by ensuring responses maintain appropriate detail levels throughout conversations. The evaluator helps prevent both information overload and insufficient explanation scenarios, contributing to more natural and effective chatbot interactions.

The answer detail analyzer 408 is a component that evaluates the appropriateness of chatbot response detail levels based on query complexity. The analyzer determines the complexity level of user queries and establishes corresponding expectations for response detail. The analyzer compares actual response detail levels against these expectations to contribute to alignment scoring. For simple queries requiring brief answers, the answer detail analyzer 408 expects and rewards concise, direct responses. For complex queries requiring detailed explanations, the analyzer expects and rewards comprehensive, step-by-step responses. The analyzer penalizes responses that are either overly verbose for simple questions or oversimplified for complex questions. The answer detail analyzer 408 operates as part of the alignment scoring system that evaluates response quality in a context-aware manner. The analyzer's output directly influences the alignment score calculation for query-answer pairs by comparing the actual detail level against the expected detail level based on query complexity. This analysis ensures responses maintain appropriate detail levels that match user needs. The analyzer's functionality aligns with the system and method 400's broader goal of improving chatbot response quality through detailed conversation analysis. The analyzer helps maintain conversation coherence by ensuring responses are neither unnecessarily detailed nor insufficiently explanatory based on query context.

The detail level comparator 410 is a component that evaluates the appropriateness of chatbot response detail relative to query complexity. The component performs a two-step analysis process. First, it assesses the complexity level of an incoming query from the query-answer pair. Second, it determines the expected level of detail for the response based on that complexity assessment. The detail level comparator 410 operates as part of the alignment scoring system. The component helps ensure responses are appropriately detailed, neither oversimplified for complex queries nor unnecessarily verbose for simple questions. For example, a simple factual query should receive a concise response, while a complex technical question warrants comprehensive step-by-step instructions. The component contributes to alignment scoring by comparing the actual detail level of the chatbot's response against the expected detail level determined from query complexity. This comparison factors into the overall alignment score calculation for the query-answer pair. The alignment scoring reflects how well the response's detail level matches user needs based on query complexity. The detail level comparator 410 supports the broader system goal of evaluating chatbot response quality in a context-aware manner. The component helps identify mismatches between query complexity and response detail that could indicate poor alignment and potential user frustration. This analysis feeds into the system and method 100's training example generation process for improving model performance.

The alignment score 412 represents a context-aware evaluation metric that assesses the appropriateness and quality of chatbot responses based on query complexity. The score measures how well an answer's level of detail matches the expected detail level for a given query complexity. For simple queries requiring brief answers, the alignment score increases when responses are concise and direct. For complex queries requiring detailed explanations, the alignment score increases when responses provide comprehensive, step-by-step information. The alignment scoring system penalizes responses that are mismatched to query complexity. Overly verbose responses to simple questions receive lower scores. Similarly, oversimplified responses to complex questions are penalized. The scoring mechanism operates at both individual message pair and conversation levels to reflect response appropriateness. The alignment score calculation considers the inherent context and complexity of a query to determine appropriate response detail levels. This context-aware approach ensures that responses align with user expectations based on query type. The scoring helps evaluate how accurately and appropriately the chatbot resolves user queries across varying complexity levels. The alignment score combines with sentiment analysis and deviation metrics to assess overall conversation quality. The score ranges from −1 to +1 and contributes to downstream processing through sentiment and alignment deviation modules and contrast score calculations.

### 2.4 Calculating a Sentiment and Alignment Deviation Composite Score

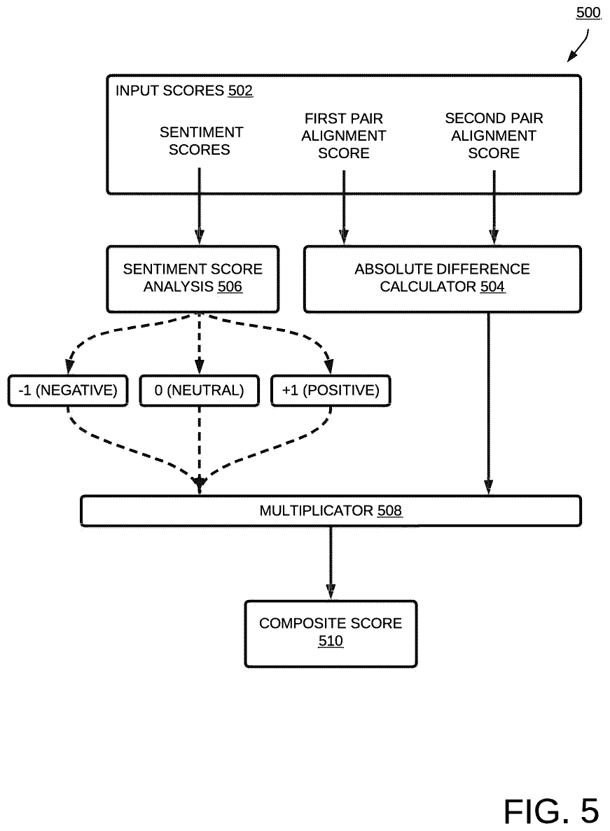

FIG. 5 illustrates a system and method 500 for calculating a SADI score by processing alignment scores and sentiment labels through multiple computational blocks, including the determination of the minimum value between pairwise sentiment scores and contextual sentiment scores, in accordance with one or more embodiments.

The calculation process involves multiple operations on alignment scores and sentiment values. The system and method 500 first computes a first deviation value by taking the absolute difference between alignment scores of consecutive query-answer pairs. The system and method 500 then determines a sentiment label for the second query-answer pair based on the minimum value between the sentiment score and contextual sentiment score (Min (Sentiment, Contextual Sentiment)), mapping negative sentiment to −1, neutral sentiment to 0, and positive sentiment to +1. The final SADI score is produced by multiplying the first deviation value with the assigned sentiment label. This approach provides a quantitative measure that combines both the change in alignment between consecutive interactions and the emotional tone of the conversation, enabling the system and method 500 to evaluate conversation quality changes as described in the system and method 100 of FIG. 1. Input scores 502 represent specific scoring elements for calculating a SADI score 510 in a generative AI chatbot conversation analysis system. Absolute difference calculator 504 computes a first deviation value calculated as the absolute difference between alignment scores of consecutive query-answer pairs. The sentiment score analysis 506 specifically handles the conversion of sentiment scores into discrete sentiment labels using a three-value classification system based on the minimum value between the pairwise sentiment score and contextual sentiment score. This analysis 506 maps the minimum sentiment scores to specific numerical values: −1 for negative sentiment, 0 for neutral sentiment, and +1 for positive sentiment. These standardized values serve as multipliers in the composite score calculation.

The multiplicator 508 performs the mathematical operation of multiplying the first deviation value by the sentiment label to produce the SADI score 510. This multiplication operation combines the magnitude of alignment change between consecutive interactions with the sentiment direction of the latter interaction. The resulting composite score provides a quantitative measure of conversation quality changes that accounts for both alignment shifts and emotional context.

The absolute difference calculator block 504 is a computational component that calculates the magnitude of change between alignment scores of consecutive, query-answer pairs in a generative AI chatbot conversation. The calculator determines the absolute value of the difference between the alignment score of a first query-answer pair and the alignment score of a subsequent second query-answer pair. The calculated absolute difference represents the raw deviation in alignment quality between consecutive interactions, regardless of whether the change was positive or negative.

The calculator 504 processes alignment scores that reflect how well a chatbot response aligns with its corresponding user query. The absolute difference calculation serves as an input for generating the SADI score. This composite score is created by multiplying the absolute difference value with a sentiment label (−1, 0, or +1) derived from sentiment analysis of the second query-answer pair.

The absolute difference calculator 504 addresses the need to quantify changes in conversation quality between sequential interactions. The calculator operates independently of sentiment, focusing solely on measuring the magnitude of alignment changes between consecutive query-answer pairs. This isolated measurement of alignment deviation provides a component that, when combined with sentiment analysis, enables the system to evaluate conversation quality trends and identify potential areas for improvement in the chatbot's response generation.

The sentiment analysis 506 is a component that processes query-answer pairs to determine sentiment scores and labels within a generative AI chatbot conversation. The block analyzes both individual message exchanges to generate pairwise sentiment scores and the entire conversation history up to the current turn to produce contextual sentiment scores, both ranging from −1 to +1. These scores are then evaluated to find their minimum value, which is converted into discrete sentiment labels: −1 for negative sentiment, 0 for neutral sentiment, and +1 for positive sentiment. The sentiment analysis operates at both a granular and holistic level, evaluating a query-answer pair independently while also considering all query-answer pairs up to and including the current turn to determine its sentiment characteristics. These sentiment scores serve as inputs for calculating the SADI score. The sentiment analysis 506 works in conjunction with alignment scoring to enable the calculation of deviation values between consecutive query-answer pairs. The sentiment labels produced by this block are multiplied with the absolute difference in alignment scores to generate the final SADI score. This multiplicator 508 allows the system to weight the magnitude of alignment changes based on the emotional context of the interaction. The sentiment analysis 506 incorporates context-aware processing capabilities that can evaluate both individual exchanges and broader conversational patterns. The analysis generates both raw decimal sentiment scores stored as metadata and discrete sentiment labels used in composite score calculations. This dual output approach enables both fine-grained analysis and simplified categorical processing for training example generation.

The multiplicator 508 represents a computational component that performs the multiplication operation between two specific values in the context of calculating a SADI score. This operation multiplies a first deviation value (calculated as the absolute difference between alignment scores of consecutive query-answer pairs) with a sentiment label value (−1, 0, or +1) derived from the sentiment score of the second query-answer pair. The multiplication operation combines the magnitude of alignment change with the directional sentiment information. The resulting product serves as the SADI score, that quantifies both the degree of change in conversation quality and the associated sentiment context. This multiplication operation is useful for creating a metric that reflects both the magnitude of alignment shifts and their emotional impact on the conversation quality.

Composite score 510 represents a computational result in the context of calculating a SADI score for analyzing chatbot conversation quality. The score 510 specifically represents the product of two key components, a first deviation value and a sentiment label. The first deviation value is calculated as the absolute difference between alignment scores of consecutive query-answer pairs. The sentiment label is derived from the sentiment score of the second query-answer pair and is mapped to discrete values (−1 for negative, 0 for neutral, +1 for positive sentiment). The multiplication of these components produces a composite score that quantifies both the magnitude of alignment change and the associated sentiment direction. This scoring mechanism helps identify significant shifts in conversation quality and user satisfaction. The output serves as a metric for evaluating conversation quality transitions and helps determine when to generate training examples for model improvement.

### 2.5 Negative Context Window

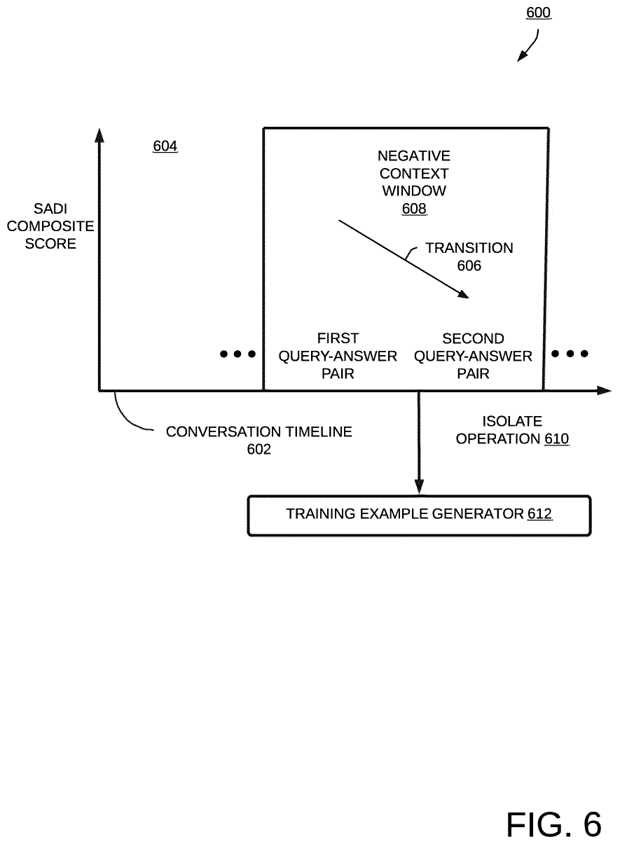

FIG. 6 illustrates a system 600 of a chatbot conversation timeline showing identification and isolation of a negative context window where conversation quality transitions from positive to negative in accordance with one or more embodiments.

The system 600 extends the system and method 100 of FIG. 1 of analyzing query-answer pairs by specifically focusing on detecting deteriorating conversation quality. When the SADI score indicates a shift from positive to negative conversation quality, the system 600 designates the relevant conversation portion as a negative context window. This negative context window encompasses the sequence of query-answer pairs where the quality degradation occurs. The system 600 then isolates this negative context window, separating the problematic conversation segment from surrounding interactions. The isolated negative context window serves as source material for generating training examples. These training examples are crafted to help the target machine learning model learn from conversations that experienced quality deterioration. This focused approach enables targeted improvement of the model's handling of potentially problematic conversation patterns.

The chatbot conversation timeline 602 represents a sequence of interactions between a user and a generative AI chatbot that exhibits a transition from positive to negative conversation quality. This conversation is specifically identified and processed when its SADI score indicates deteriorating conversation quality. The conversation includes query-answer pairs that are analyzed for both alignment between questions and answers as well as sentiment indicators.

The conversation serves as source material for identifying problematic interaction patterns. The system and method 600 isolates portions of this conversation where the quality transitions from positive to negative into a negative context window. These isolated segments provide focused training examples that help improve the chatbot's performance in similar situations.

The conversation analysis includes measuring how well a answer aligns with its corresponding query through alignment scores. The system and method 600 also evaluates sentiment scores for a query-answer exchange. When combined, these metrics help identify exactly where and how the conversation quality degraded.

The negative portions of conversation 602 are useful for training purposes. By isolating these segments, the system and method 600 can generate targeted training examples that help the model learn to avoid similar negative transitions in future conversations. This focused approach prevents positive and negative sentiments from different parts of the conversation from canceling each other out during analysis.

The conversation represents a practical example of how the system and method 600 identifies, processes, and utilizes problematic chat interactions to improve the underlying AI model's performance through targeted training data generation.

The chart 604 represents sequential interactions between a user and a generative AI chatbot within a conversation, specifically focusing on pairs that demonstrate a transition from positive to negative conversation quality. These pairs are components analyzed for identifying negative context windows in chatbot conversations. The query-answer pairs include user queries and corresponding chatbot responses that are evaluated using both alignment and sentiment analysis. The alignment score measures how well the chatbot's answer matches the user's query, while the sentiment score reflects the emotional tone or satisfaction level within the interaction. When these pairs show a decline in conversation quality (indicated by the SADI score), they are grouped into a negative context window. This window captures the specific portion of the conversation where the quality deteriorated, allowing for focused analysis and training data generation.

The system and method 600 processes these pairs through specialized models to calculate precise metrics. The alignment analysis model evaluates response appropriateness, while the sentiment analysis model assesses user satisfaction. These scores are combined to create a composite metric that identifies quality transitions within the conversation. The identified query-answer pairs within negative context windows serve as training examples for improving the target machine learning model. By isolating these specific conversation segments, the system and method 600 can focus on problematic interactions and develop more effective responses for similar situations in future conversations.

The sentiment and alignment score transition 606 represents a graphical interface component that displays the quality transitions within chatbot conversations, specifically focusing on alignment scores and sentiment metrics. This visualization component helps identify and analyze negative context windows where conversation quality deteriorates from positive to negative states.

The transition 606 tracks alignment scores between query-answer pairs, that measure how well chatbot responses match user queries alongside sentiment scores that reflect the emotional tone of interactions. The component displays these metrics chronologically, enabling clear identification of quality transitions across consecutive query-answer pairs in the conversation.

The transition 606 is particularly useful for isolating negative context windows, that occur when the SADI score indicates a decline in conversation quality. These windows are useful for generating targeted training examples to improve the chatbot's performance. The transition 606 helps analysts and system operators quickly identify these problematic conversation segments where positive interactions transition to negative ones.

The transition 606 integrates with the system's data processing pipeline to display both granular message-level scores and aggregate conversation metrics. The component supports the weighted scoring mechanism that places greater emphasis on recent messages, helping to accurately represent the evolving nature of conversations. This visualization serves as a tool for identifying conversation segments that require intervention or can be used for model improvement.

The negative context window 608 represents a specific segment of a generative AI chatbot conversation where conversation quality transitions from positive to negative. This window is identified through analysis of SADI scores. The negative context window encompasses a portion of conversation including sequential query-answer pairs where the quality metrics indicate deterioration.

The window is determined by analyzing both alignment scores between queries and answers as well as sentiment scores for a query-answer pair. When the SADI score indicates a decline in conversation quality, that portion of the conversation is marked as a negative context window. This segmentation helps isolate problematic conversation sequences for targeted analysis and improvement.

The negative context window serves as a focused source for generating training examples. By isolating these specific conversation segments where quality degraded, the system and method 600 can create more precise training data. This targeted approach prevents positive and negative sentiments from different parts of a conversation from obscuring each other during analysis.

The window 608 provides useful context for understanding where and why conversation quality declined. This information is particularly useful for fine-tuning language models to better handle similar situations in future conversations. The negative context window helps identify specific points where the chatbot's responses failed to maintain positive user engagement or adequately address user queries.

The isolation operation 610 refers to a specific process of separating and extracting a negative context window from a generative AI chatbot conversation for training purposes. The operation occurs when a SADI score indicates a transition from positive to negative conversation quality within a portion of the conversation including sequential query-answer pairs.

The isolation operation specifically targets conversation segments where the quality deteriorates, as measured by alignment scores between queries and answers and sentiment scores of the interactions. This operation extracts these problematic conversation segments to create focused training examples. The operation helps prevent positive and negative sentiments from different parts of a conversation from canceling each other out during analysis.

The isolation operation serves as a useful preprocessing step for model improvement. By isolating specific negative context windows, the operation enables more precise training data generation. This targeted approach allows language models to focus on particular conversation segments where quality degradation occurred rather than processing entire conversations that may include irrelevant exchanges.

The operation supports the system and method 600's ability to identify and analyze specific points of conversation breakdown. Through this isolation, the system and method 600 can better understand what led to negative user experiences and generate training examples that help prevent similar quality degradation in future interactions.

The training example generator 612 is a component responsible for creating training examples from isolated negative context windows in chatbot conversations. The generator processes conversation segments where the SADI score indicates a transition from positive to negative conversation quality.

The training example generator 612 specifically focuses on portions of conversations including query-answer pairs that demonstrate deteriorating interaction quality. These portions are identified through alignment scores between queries and answers as well as sentiment scores that reflect user satisfaction. The training example generator 612 isolates these negative context windows to prevent mixing with positive conversation segments that could dilute the training signal.

The training example generator 612 operates as part of a larger data processing pipeline that analyzes chatbot conversations. The training example generator 612 generates training examples that help improve the target machine learning model's ability to handle challenging conversation scenarios. The training examples created focus specifically on conversation segments where user satisfaction declined, allowing the model to learn from these problematic interactions.

The training example generator 612 supports the system and method 600's goal of continuous model improvement by creating focused training data from real-world negative user experiences. The training example generator 612's isolation of negative context windows ensures that the training examples clearly demonstrate the specific conversation patterns and responses that led to decreased user satisfaction.

### 2.6 Extracting Topic and Question-Type Classifications

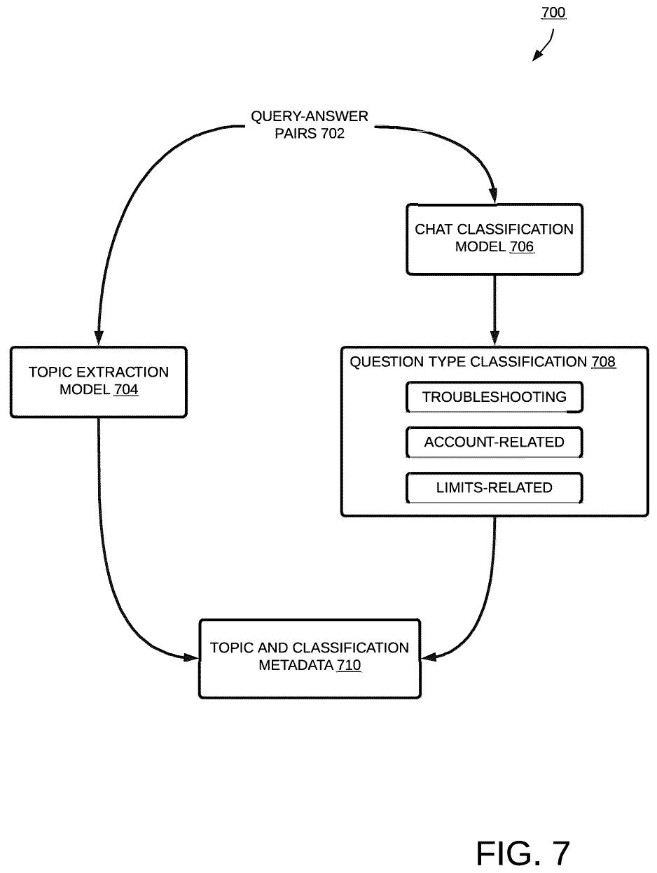

FIG. 7 illustrates a system and method 700 for extracting topic clusters and determining question type classifications from query-answer pairs 702 and storing these classifications as associated metadata in accordance with one or more embodiments.

The system and method 700 extends the base conversation analysis of the system and method 100 of FIG. 1 by incorporating additional classification layers. A topic extraction model 704 processes the query-answer pairs 702 to determine overarching conversation subjects. Simultaneously, a chat classification model 706 analyzes individual query-answer pairs 702 to categorize question types into specific question type classifications 708, such as troubleshooting, account-related, or limits-related inquiries. The extracted topic clusters and question type classifications are stored as metadata 710 linked to the generative AI chatbot conversation. This classification process works in conjunction with the alignment scoring and sentiment analysis framework of the system and method 100 of FIG. 1 to provide a more comprehensive understanding of the conversation dynamics. The metadata storage enables future reference and analysis of conversation patterns while maintaining the context of sentiment and alignment measurements established in the embodiment of FIG. 1.

A chat conversation data structured data storage component includes query-answer pairs 702 from generative AI chatbot conversations along with their associated metadata. The component stores multiple types of conversation-related information, including topic clusters extracted by a topic extraction model 704 and question type classifications 708 determined by a chat classification model 706. The question type classifications 708 specifically categorize queries into predefined categories, such as troubleshooting, account-related, and limits-related issues. The data storage component serves as a foundation for analyzing conversation quality through alignment scores and sentiment analysis. The data structure maintains the sequential nature of query-answer pairs 702 within conversations, enabling analysis of how conversation quality changes between consecutive interactions. The metadata storage capability allows for efficient organization and retrieval of conversation attributes for downstream processing and model training purposes.

The topic extraction model 704 is a specialized machine learning component designed to identify and extract broad subject areas or pain points from query-answer pairs 702 within generative AI chatbot conversations. The model analyzes conversation content to determine primary topics, such as, for example, virtual machine (VM) connectivity issues, account closure requests, and billing issues. This model 704 operates at both individual query-answer pair level and across entire conversations to capture topic transitions when users switch context during interactions.

The topic extraction model 704 works in conjunction with a chat classification model 706 to provide comprehensive conversation analysis. While the topic extraction model 704 identifies the broad subject matter, the chat classification model 706 categorizes specific question types, such as troubleshooting, account-related, or limits-related queries. The extracted topic clusters are stored as metadata associated with the conversation, enabling downstream analysis and improvement of chatbot performance.

The model 704 functions as part of a larger data processing pipeline that processes both explicit and implicit user feedback signals. The topic clusters generated by this model 704 help service teams improve documentation and identify enhancement opportunities based on frequently discussed topics and user pain points. The model 704's output contributes to the system and method 700's ability to track conversation patterns and generate business analytics insights.

The topic extraction model 704 supports the system and method 700's sentiment and alignment analysis capabilities by providing topical context that helps evaluate the appropriateness and quality of chatbot responses within specific subject domains. The model 704's classifications enable more accurate tracking of user satisfaction across different topic areas and conversation types.

The chat classification model 706 is a specialized machine learning component designed to categorize individual query-answer pairs within generative AI chatbot conversations. The model 706 analyzes a query-answer exchange and assigns specific question type classifications, including troubleshooting queries, account-related inquiries, and limits-related questions. The chat classification model 706 operates at the granular level of individual message pairs rather than processing entire conversations.

The model 706 works in conjunction with the topic extraction model 704 to provide comprehensive conversation analysis. While the topic extraction model 704 identifies broad subject areas and pain points, the chat classification model 706 focuses specifically on the nature and purpose of a query. This classification helps track patterns in user interactions and identifies common types of support requests.

The chat classification model 706 contributes to the system and method 700's ability to process both direct and indirect user feedback by providing structured categorization data. The model 706's classifications are stored as metadata associated with conversations, enabling downstream analysis of user interaction patterns and documentation needs. These classifications help service teams understand usage patterns and improve documentation based on the types of questions users frequently ask.

The model 706's output integrates with the system and method 700's sentiment and alignment deviation analysis, providing context for why certain interactions may show positive or negative sentiment shifts. This classification data is particularly useful when generating training examples for improving the target machine learning model's performance across different types of user inquiries.

The question type classification options 708 represent a set of predefined categories used to classify different types of queries within a generative AI chatbot conversation. The classification options specifically include, in one example implementation, troubleshooting queries, account-related queries, and limits-related queries. These classifications are determined by a chat classification model 706 that analyzes individual query-answer pairs within the conversation.

The classification system operates as part of a broader conversation analysis framework that processes both sentiment and alignment metrics. The chat classification model 706 works in conjunction with a topic extraction model 704 to provide comprehensive metadata about the nature and intent of a conversation. This classification helps in understanding the primary purpose of user interactions.

These classifications are particularly relevant for analyzing customer support interactions. The system and method 700 uses these classifications to identify patterns in user inquiries and track different types of support needs. For example, troubleshooting classifications may indicate technical issues, account-related classifications may involve user access or management concerns, and limits-related classifications may pertain to service restrictions or quotas.

The classification results are stored as metadata associated with a conversation, enabling downstream analysis and reporting. This metadata contributes to the system and method 700's ability to generate actionable insights for service teams and improve documentation based on the types of questions being asked. The classification system supports the broader goal of understanding user needs and improving chatbot responses across different types of inquiries.

The topic and classification metadata 710 represents a system component responsible for storing and managing conversation-related metadata extracted from chatbot interactions. This storage specifically handles the storage of topic clusters and question type classifications derived from query-answer pairs in generative AI chatbot conversations. The storage maintains associations between these classifications and their corresponding conversations.

The topic and classification metadata 710 processes two primary types of metadata. One, it stores topic clusters that are extracted using a topic extraction model 704, that identifies broad subject areas of conversation, such as virtual machine (VM) connectivity issues, account closure requests, or billing matters. Two, it maintains question type classifications determined by a chat classification model 706, that categorizes queries into specific types, including troubleshooting, account-related, and limits-related queries.

The topic and classification metadata 710 operates as part of a larger analysis system that processes conversations at both individual question-answer pair levels and complete conversation levels. The stored metadata supports downstream processing tasks and enables the generation of business intelligence insights. The storage functionality aligns with analyzing conversations using trained models to extract multiple types of information, including conversation topics and intents. The stored metadata facilitates the system and method 700's ability to aggregate and analyze query-level and query-answer level information for service team improvements and documentation enhancement.

### 2.7 Generating Training Examples Through Retrieval Augmented Generation (Rag) Document Analysis

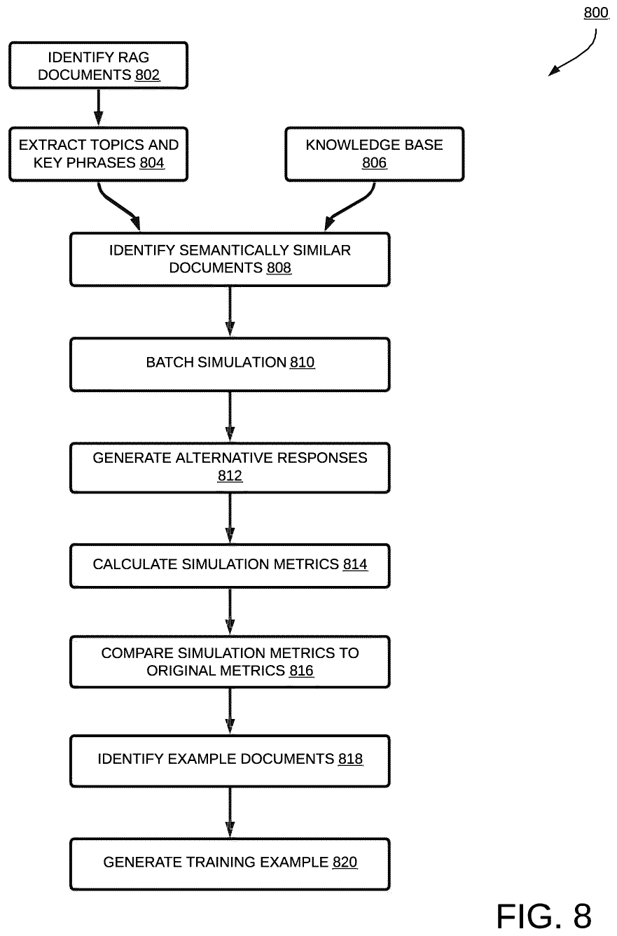

FIG. 8 illustrates a method 800 of generating training examples through RAG document analysis, batch simulation, and comparative metric evaluation for machine learning model improvement, which complements the DPP3 application's simulation capabilities while focusing specifically on training example generation, in accordance with one or more embodiments.

The embodiment 800 begins by identifying RAG documents linked to a query-answer pair from a chatbot conversation (Operation 802). Topics and key phrases are extracted from these RAG documents (Operation 804) to find semantically similar documents (Operation 808) within a knowledge base 806. The embodiment 800 then conducts batch simulation by reseeding the original query with the identified similar documents (Operation 810). Alternative responses are generated using these similar documents (Operation 812). The embodiment 800 evaluates these alternative responses by calculating simulation metrics, including sentiment, alignment, and context scores (Operation 814). These simulation metrics undergo comparison with the original query-answer pair metrics (Operation 816). Through this comparison, documents are classified as positive examples when leading to improved metrics or negative examples when maintaining poor metrics (Operation 818). The final training example incorporates these classifications, with positive example documents labeled as positive training samples and negative example documents labeled as negative training samples (Operation 820). This systematic approach enhances the training example generation of the system and method 100 of FIG. 1 by incorporating document-level analysis and comparative metrics to create refined training data for machine learning model improvement.

Identify RAG documents 802 refers to a process of determining and collecting RAG documents that were used in generating responses for a specific query-answer pair within a chatbot conversation. The RAG documents represent the source material or knowledge base content that the chatbot system referenced when formulating its response to the user's query.

This identification process serves as the initial step in a broader training example generation workflow. The process specifically targets RAG documents associated with query-answer pairs where sentiment and alignment deviation analysis has indicated potential issues or areas for improvement. These documents are identified to understand the source material that led to particular conversation outcomes.

The identification process operates within the context of analyzing chatbot conversation quality through sentiment and alignment scores. The identified RAG documents become source material for subsequent analysis steps, including topic extraction and key phrase identification. These documents support understanding why certain responses may have led to positive or negative user experiences.

The process connects to a larger system that uses document analysis to improve chatbot performance. By identifying the specific RAG documents used in conversations, the embodiment 800 can trace the relationship between source documentation and conversation outcomes. This traceability enables the embodiment 800 to evaluate and improve both the document selection process and the underlying knowledge base content.

The identification step serves as the foundation for generating new training examples through simulation and comparison processes. The identified documents become the basis for finding semantically similar content and evaluating alternative response paths that could potentially lead to better conversation outcomes.

Extract topics and key phrases 804 represents a processing component within a document analysis system for chatbot conversations. This component performs automated analysis of RAG documents associated with query-answer pairs in chatbot interactions. The component systematically processes RAG documents to identify and extract two main types of information, topic categories and key phrases. Topics represent broader subject areas or themes within the documents, while key phrases are specific, meaningful word combinations that capture important concepts or terminology. The extracted information serves as semantic markers for identifying similar documents within a knowledge base.

The extraction process operates as part of a larger training example generation workflow, where the identified topics and key phrases enable semantic matching to find documents with similar content. This semantic matching capability is useful for the batch simulation process, where alternative conversation paths are explored using semantically related documents.

The component's output directly supports document similarity matching, that is useful for identifying both positive examples (documents leading to improved conversation metrics) and negative examples (documents maintaining negative metrics) during simulation. These labeled examples serve as training data for improving the target machine learning model's performance.

The extraction process is designed to work within the context of chatbot conversations, focusing on identifying content that is relevant to user queries and chatbot responses. This contextual awareness ensures that the extracted topics and phrases maintain relevance to the conversation's subject matter and intent.

The knowledge base 806 represents a repository of documents and information used in RAG processes for chatbot interactions. The knowledge base 806 serves as a source for identifying semantically similar documents during conversation analysis and simulation. The knowledge base 806 includes documents that can be analyzed for topics and key phrases to find content similarities. These documents are used in batch simulation processes where a query is reseeded with different document combinations to evaluate alternative conversation paths. The repository enables the embodiment 800 to identify both positive example documents that improve conversation metrics and negative example documents that maintain poor performance.

The knowledge base 806 supports multiple content types, including text, images, videos, and other multimedia content. The embodiment 800 can process this diverse content to handle conversations involving various communication modalities. The knowledge base 806 is particularly useful for addressing documentation challenges, for it helps identify duplicate content and overlapping concepts across multiple services.

The knowledge base 806 integrates with the embodiment 800's document analysis capabilities, supporting metrics like readability scores, completeness scores, query-document relevancy scores, and query answerability scores. These metrics help evaluate document quality and effectiveness in supporting chatbot responses. The repository supports generating training examples by providing the document context necessary for model improvement and fine-tuning.

Identify semantically similar documents 808 refers to a process component that searches for and retrieves documents from a knowledge base 806 that shares semantic meaning with the RAG documents used in a chatbot conversation. The component operates by analyzing extracted topics and key phrases from the original RAG documents associated with a query-answer pair.

The identification process specifically targets documents that are conceptually related to the conversation context where sentiment and alignment scores indicate a quality change between consecutive query-answer pairs. This component works in conjunction with alignment scoring and sentiment analysis to find alternative documents that could potentially improve conversation quality.

The semantic similarity search considers both topical relevance and phrase-level matching. The embodiment 800 employs document embedding and vector search methods along with topic search approaches to locate documents that are semantically aligned with the original content. The key-phrase search functionality identifies documents including semantically similar key-phrases as part of this retrieval process.

The identified similar documents serve as input for batch simulation testing where they are used to generate alternative conversation paths. These documents are evaluated based on their ability to improve conversation metrics compared to the original interaction with documents being classified as either positive examples (leading to improved metrics) or negative examples (maintaining poor metrics).

This identification process is particularly useful for the embodiment 800's training data generation pipeline, for it helps create labeled examples for model improvement while also supporting the detection of duplicate or overlapping content in the knowledge base.

Batch simulation 810 refers to a systematic process of testing alternative conversation paths using semantically similar documents to improve chatbot response quality. The batch simulation component takes a query from a query-answer pair that has been identified as problematic through sentiment and alignment analysis and experiments with different document combinations from the knowledge base to find better potential responses.

The simulation process begins by identifying RAG documents associated with the original conversation. The embodiment 800 extracts topics and key phrases from these documents to find semantically similar content in the knowledge base. The simulation then reseeds the original query with these alternative documents to generate new potential responses.

The batch simulation evaluates a alternative response using multiple metrics, including sentiment scores, alignment scores, and context scores. These simulated responses are compared against the original conversation metrics to identify that document combinations lead to better outcomes. Documents that produce improved metrics are labeled as positive training examples, while those that maintain negative metrics are labeled as negative examples.

The simulation operates in a controlled environment where the chatbot agent has access to the selected similar documents rather than the full knowledge base. This focused approach allows for systematic testing of different document combinations and their impact on response quality. The results directly contribute to training data generation for improving the underlying machine learning models.

This component serves as a useful feedback mechanism for identifying both effective and problematic content in the knowledge base while generating valuable training examples for model improvement. The simulation results help optimize document selection and response generation for future similar conversations.

Generate alternative responses 812 represents a processing step in a training example generation workflow for improving chatbot performance. This component generates alternative chatbot responses using semantically similar documents identified from a knowledge base. The generation process begins after identifying RAG documents associated with a query-answer pair and extracting their topics and key phrases.

The response generation operates through a batch simulation process that reseeds the original query with the newly identified similar documents. The component specifically focuses on generating responses using the selected similar documents rather than the entire knowledge base, creating a controlled simulation environment. The generated alternative responses serve as experimental variations to evaluate potential improvements over the original chatbot response.

The response generation process works in conjunction with document caching mechanisms that allow dynamic selection and combination of documents based on evolving conversation context. The cross-encoder attention module can flexibly access these cached documents when formulating responses during the simulation phase. This approach enables exploration of different response variations while maintaining contextual relevance.

The generated alternative responses undergo evaluation through multiple simulation metrics, including sentiment scores, alignment scores, and context scores. These metrics help determine if the alternative responses represent improvements over the original interaction. The evaluation results directly contribute to identifying positive and negative document examples for model training purposes.

Calculate simulation metrics 814 refers to a process of evaluating alternative responses generated during batch simulation of chatbot conversations. The process involves computing three key metrics for an alternative response: (1) a simulated sentiment score measures the emotional tone and user satisfaction level of the simulated response; (2) a simulated alignment score evaluates how well the generated response matches and addresses the user's query; and (3) a simulated context score assesses the overall coherence and appropriateness of the response within the conversation flow.

These metrics are calculated to compare the performance of responses generated using semantically similar documents against the original conversation metrics. The comparison helps identify that alternative document combinations produce better or worse outcomes than the original interaction.

The calculation process supports the broader goal of identifying effective versus problematic content in the knowledge base. Documents leading to improved metrics become positive training examples. Documents resulting in maintained negative metrics are flagged as negative examples requiring improvement.

The metrics calculation is part of a systematic approach to evaluate simulated conversations and generate labeled training data for model improvement. The process leverages both sentiment analysis and alignment scoring capabilities to comprehensively assess response quality. The calculated metrics provide quantitative measures for evaluating alternative conversation paths and document effectiveness.

Compare simulation metrics to original metrics 816 represents an evaluation step in the training example generation process for improving chatbot performance. This component performs a comparative analysis between metrics calculated from simulated alternative responses and the original metrics from the actual query-answer pair interaction.

The comparison specifically evaluates three key metric types: simulated sentiment scores, simulated alignment scores, and simulated context scores against their corresponding original values. The sentiment scores measure the emotional tone of responses, alignment scores assess how well responses match queries, and context scores evaluate the overall coherence of the interaction.

This comparison serves as a decision mechanism for identifying effective versus problematic document selections. Documents that produce improved metrics in simulation compared to the original interaction are classified as positive examples. Conversely, documents that maintain or worsen the original negative metrics are classified as negative examples.

The comparative analysis influences the quality of training data generation. The embodiment 800 uses the comparison results to label documents appropriately for model training with documents leading to better metrics becoming positive training samples and those maintaining poor performance becoming negative training samples. These labeled examples are then used to update the parameters of retrieval and ranking models to improve future document selection.

The metrics comparison process operates within a larger batch simulation framework where the embodiment 800 experiments with different document combinations to find optimal response patterns. This systematic evaluation helps identify both effective content and problematic documentation that needs improvement, contributing to continuous system enhancement and documentation refinement.

Identify example documents 818 refers to a process within a RAG system that evaluates and categorizes documents based on their effectiveness in chatbot conversations. The process identifies two distinct categories of documents from a knowledge base, positive example documents and negative example documents.

The identification process begins by analyzing RAG documents associated with a query-answer pair. The system extracts topics and key phrases from these documents to find semantically similar documents in the knowledge base. Through batch simulation, these documents are tested by reseeding them into the original query to generate alternative responses.

The effectiveness of a document is determined by comparing simulation metrics (sentiment score, alignment score, and context score) against the original conversation metrics. Documents that produce improved metrics are labeled as positive examples, indicating their ability to enhance conversation quality. Conversely, documents that maintain negative metrics are labeled as negative examples, signifying problematic content that requires improvement.

This identification process serves a useful role in generating training examples for model improvement. The embodiment 800 uses these labeled documents to create training samples, where positive example documents become positive training samples, and negative example documents become negative training samples. These labeled examples are then used to update and refine the target machine learning model's parameters.

The process specifically addresses the challenge of identifying effective versus problematic documentation within large-scale knowledge bases, enabling continuous improvement of both the chatbot's response generation and the underlying documentation quality.

Generate training example 820 represents a process for creating training examples through document analysis and simulation in the context of improving chatbot performance. The process begins by identifying RAG documents linked to a specific query-answer exchange. These documents serve as the foundation for generating new training data.

The process involves multiple analytical steps. First, topics and key phrases are extracted from the RAG documents using specialized models. These extracted elements are then used to search a knowledge base for semantically similar documents, creating a broader set of relevant content.

The training example generation implements a batch simulation approach. This simulation takes the original query and reseeds it with the identified similar documents. The chatbot generates alternative responses using these documents, allowing for exploration of different potential conversation paths.

The embodiment 800 evaluates the quality of simulated responses through multiple metrics. These include sentiment scores that measure user satisfaction, alignment scores that assess response appropriateness, and context scores that evaluate conversation coherence. These simulation metrics are compared against the original conversation's metrics to identify improvements or degradations in performance.

Documents are classified based on their impact on conversation quality. Documents leading to improved metrics are labeled as positive training samples, while those maintaining negative metrics are labeled as negative training samples. This binary classification creates a structured training dataset for model improvement.

The process specifically addresses the challenge of improving chatbot performance by creating high-quality training data through systematic document analysis and simulation. The approach leverages both positive and negative examples to help the model learn optimal document selection and response generation strategies.

### 2.8 Target Machine Learning Model

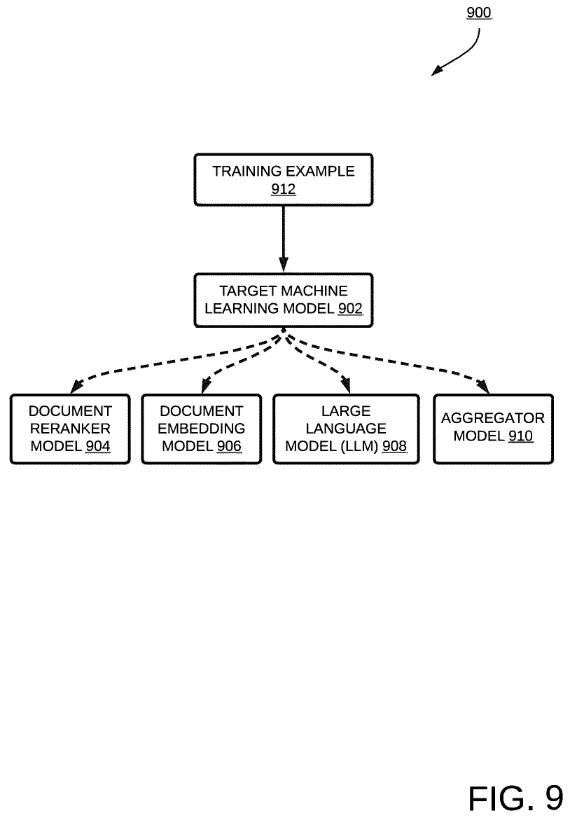

FIG. 9 illustrates a system 900 of alternative target machine learning model types, including a document reranker model, document embedding model, LLM, and aggregator model that receive training examples. The system 900 extends the system and method 100 of FIG. 1 of analyzing query-answer pairs and generating training examples by specifically defining the target machine learning model as one of four distinct types. The target model can be implemented as a document reranker model for optimizing document ranking, a document embedding model for converting text into numerical representations, an LLM for natural language processing tasks, or an aggregator model for combining multiple data sources or outputs. This specification of model types provides concrete implementation options for the machine learning system that processes the sentiment and alignment scores derived from the chatbot conversations.

The target machine learning model 902 represents one of four specific types of models that can be updated using training examples generated from chatbot conversation analysis. The model can be either a document reranker model for improving document ranking and selection, a document embedding model for enhancing document representation in vector space, an LLM for generating responses, or an aggregator model for combining multiple components.

The model receives training examples based on SADI scores calculated from query-answer pairs in chatbot conversations. These scores reflect changes in conversation quality by analyzing alignment between questions and answers, as well as user sentiment. The training examples help the model learn from real-world interactions and user feedback.

For document reranker and embedding models, the training improves document selection and representation capabilities. For LLMs, the training enhances response generation and alignment with user needs. For aggregator models, the training optimizes how different components work together. The model's parameters are updated using these training examples to continuously improve performance based on actual user interactions.

The training process leverages both explicit user feedback (like thumbs up/down ratings) and implicit signals (like conversation abandonment or escalations) to generate high-quality training data. This approach enables continuous model improvement aligned with real customer behavior scenarios and helps prevent performance degradation over time.

The document reranker model 904 is a specialized machine learning model that serves as a target for training example updates within the context of improving generative AI chatbot conversations. The model functions as a component that reranks retrieved documents based on their relevance and appropriateness to user queries. The document reranker model receives training examples generated from query-answer pairs that demonstrate significant changes in conversation quality as measured by SADI scores.

The model's training is driven by analyzing pairs of consecutive interactions in chatbot conversations. These training examples are specifically derived from portions of conversations where alignment scores between queries and answers show meaningful changes. The document reranker model learns from both positive and negative examples, where positive examples demonstrate improved conversation quality, and negative examples highlight areas needing improvement.

The document reranker model processes documents through multiple analytical steps, including evaluation of query-document relevancy scores and query-answer answerability scores. The model incorporates direct customer feedback as training data and utilizes conversation simulation results to identify both effective and problematic document selections. Through continuous parameter updates based on generated training examples, the document reranker model progressively improves document selection accuracy for chatbot responses.

The model operates within a larger framework that includes sentiment analysis and alignment scoring mechanisms, ensuring that document ranking decisions align with both technical accuracy and user satisfaction metrics. This comprehensive approach enables the document reranker model to optimize document selection based on real-world interaction patterns and explicit user feedback.

The document embedding model 906 is a specialized machine learning model that serves as one of the potential target models for updating based on training examples derived from chatbot conversations. This model creates vector representations (embeddings) of documents from a knowledge base, enabling efficient semantic search and comparison of documents. The document embedding model processes documents used in chatbot responses to create numerical representations that capture the semantic meaning and context of the document content.

The model is specifically trained using examples generated from query-answer pairs where sentiment and alignment deviation scores indicate significant changes in conversation quality. These training examples help the model learn to create more effective document embeddings that better represent the semantic relationships between documents and user queries. The embeddings are particularly important for identifying similar or duplicate content across large documentation sets.

The document embedding model works in conjunction with the embodiment 900's document analysis capabilities, including topic clustering, key-phrase extraction, and readability scoring, to enable more accurate document selection during chatbot interactions. The model's embeddings facilitate the identification of semantically similar documents during conversation simulations, helping to improve document retrieval accuracy and reduce redundancy in the knowledge base.

Through continuous updates based on user interactions and feedback, the document embedding model learns to create more refined vector representations that better capture the nuances of technical documentation and improve the overall effectiveness of the chatbot's document retrieval capabilities.

The LLM 908 is a specialized machine learning model that serves as one of the potential target models for parameter updates based on training examples generated from chatbot conversations. The LLM processes and generates natural language text by leveraging patterns learned from extensive training data. In the context of the generative AI chatbot system, the LLM receives training examples derived from query-answer pairs that exhibit specific sentiment and alignment characteristics.

The LLM's parameters are updated using training examples generated when SADI scores indicate significant changes in conversation quality. These training examples are specifically created from query-answer pairs where the system has detected meaningful patterns in user-chatbot interactions. The LLM functions as a core component that can be fine-tuned to improve response generation based on real-world conversation data.

The system utilizes direct customer feedback from positive and negative conversations to fine-tune the LLM through A/B testing frameworks. The LLM processes indirect feedback derived from user behavior tracking along with sentiment and alignment scores for automated conversation classification. The model particularly benefits from conversations showing sentiment shifts, that serve as hard training samples for model alignment.

Through continuous parameter updates based on these training examples, the LLM adapts to better handle similar conversational scenarios in future interactions. This targeted updating process helps maintain and improve the LLM's ability to generate appropriate, contextually relevant responses while addressing identified areas of conversation quality changes.

The aggregator model 910 is a specialized machine learning model that serves as one of the potential target models for training example updates in the context of improving generative AI chatbot conversations. The aggregator model processes and combines various conversation metrics, including alignment scores and sentiment scores from query-answer pairs, to optimize chatbot response generation. This model receives training examples generated from conversation segments that are identified through SADI scores.

The aggregator model functions as a component that can be fine-tuned based on real-world interaction data. The model learns from training examples derived from query-answer pairs where significant changes in conversation quality have been detected. These training examples are specifically generated when the SADI scores indicate notable patterns in conversation quality.

The model operates within a broader system that analyzes both the alignment between queries and answers and the sentiment expressed in conversations. Through continuous updates to its parameters using carefully selected training examples, the aggregator model improves its ability to process and combine various conversation metrics effectively. The model's training is driven by direct customer feedback and behavioral patterns observed in chatbot interactions.

The aggregator model represents one of several possible target models that can be updated through this training process, alongside document rerankers, document embedding models, and LLMs. This model specifically focuses on aggregating and processing conversation metrics to enhance the overall quality of chatbot interactions.

Training example 912 represents a data instance generated from a query-answer pair that exhibits significant sentiment and alignment deviation within a chatbot conversation. The training example is specifically used to update one of four distinct model types: a document reranker model, a document embedding model, an LLM, or an aggregator model. The training example is created when the SADI score, calculated from alignment scores of consecutive query-answer pairs and sentiment analysis, indicates a notable change in conversation quality. The training example serves as input data for model fine-tuning, helping improve the selected model's performance in handling similar conversational scenarios. The training example is derived from the second query-answer pair in the conversation sequence, capturing the context where sentiment or alignment shifts occurred. This approach enables targeted improvement of specific model components based on real-world interaction patterns and user feedback.

### 3.0 Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

A cloud service provider employs a generative AI chatbot to assist users with container orchestration service configurations. One or more embodiments processes conversations where users interact with the chatbot about KUBERNETES cluster setup and management.

Consider a first query-answer pair, where a user asks the following: “How do I configure auto-scaling for my Kubernetes cluster?” The chatbot responds with specific steps for implementing horizontal pod autoscaling, including commands for setting resource utilization thresholds. The alignment analysis model evaluates this pair and assigns a high alignment score of 0.92, indicating strong semantic correspondence between the question about auto-scaling and the detailed configuration instructions provided.

The user follows up with a second query: “The autoscaling isn't working even after following these steps. My pods aren't scaling when CPU usage spikes.” The chatbot responds by suggesting generic troubleshooting steps without addressing the specific scaling failure scenario. The alignment analysis model processes this second pair and assigns a lower alignment score of 0.45, reflecting misalignment between the specific scaling problem and the generic response. The sentiment analysis model analyzes the second query-answer pair and assigns a negative sentiment score of −0.65, capturing user frustration with the unresolved scaling issue.

The embodiment calculates a SADI score using the alignment scores (0.92 and 0.45) and sentiment score (−0.65). The substantial drop in alignment combined with negative sentiment yields a composite score of −0.71, indicating significant conversation quality degradation. This score triggers training example generation.

The generated training example pairs the specific auto-scaling troubleshooting query with an improved response that includes common causes of scaling failures, such as misconfigured resource metrics or incorrect deployment specifications. The target machine learning model updates parameters based on this example, enhancing future responses to similar auto-scaling troubleshooting scenarios.

The embodiment thus captures the transition from effective initial documentation delivery to inadequate problem resolution, using this pattern to improve the chatbot's troubleshooting capabilities for cloud infrastructure management.

### 4. Practical Applications, Advantages, and Improvements

One or more embodiments enhances automated support systems through systematic analysis and improvement of chatbot conversations. One or more embodiments applies continuous learning from real user interactions, enabling rapid adaptation to emerging support patterns and issues.

A primary application involves processing multi-turn conversations where initial responses fail to resolve user queries. The alignment scoring mechanism identifies semantic drift between queries and responses across conversation turns. The sentiment analysis captures user satisfaction degradation when responses become less relevant or helpful. The composite scoring system combines these metrics to detect conversation segments requiring improvement, creating a quantitative basis for training data generation.

Technical advantages emerge from automated identification of problematic response patterns. One or more embodiments eliminates manual review bottlenecks by programmatically detecting misaligned responses and negative sentiment progressions. The generation of targeted training examples focuses model updates on specific failure modes observed in production conversations. The systematic parameter updates improve response accuracy for similar future queries.

One or more embodiments provides particular benefits for cloud service providers managing complex technical documentation. One or more embodiments automatically identifies documentation gaps and inconsistencies through alignment score analysis. The sentiment tracking reveals user frustration points tied to specific technical topics or service features. The composite scoring helps prioritize documentation improvements based on user impact.

Practical improvements extend to handling novel technical issues. When users encounter undocumented problems, the alignment scoring detects response inadequacy. The sentiment analysis confirms user dissatisfaction. The automated training example generation captures these scenarios for model enhancement. The continuous learning cycle accelerates adaptation to emerging technical support needs.

One or more embodiments advances chatbot functionality through measurable quality metrics. The alignment scoring provides objective response evaluation. The sentiment analysis adds user experience context. The composite scoring enables systematic quality tracking. The automated training generation creates targeted improvements. The parameter updates deliver measurable performance gains.

Implementation advantages include reduced manual oversight requirements. The automated scoring removes subjective quality assessment. The systematic example generation eliminates manual training data creation. The targeted parameter updates focus computational resources on relevant improvements. The continuous adaptation maintains support quality at scale.

### 5. Example Llm Architecture

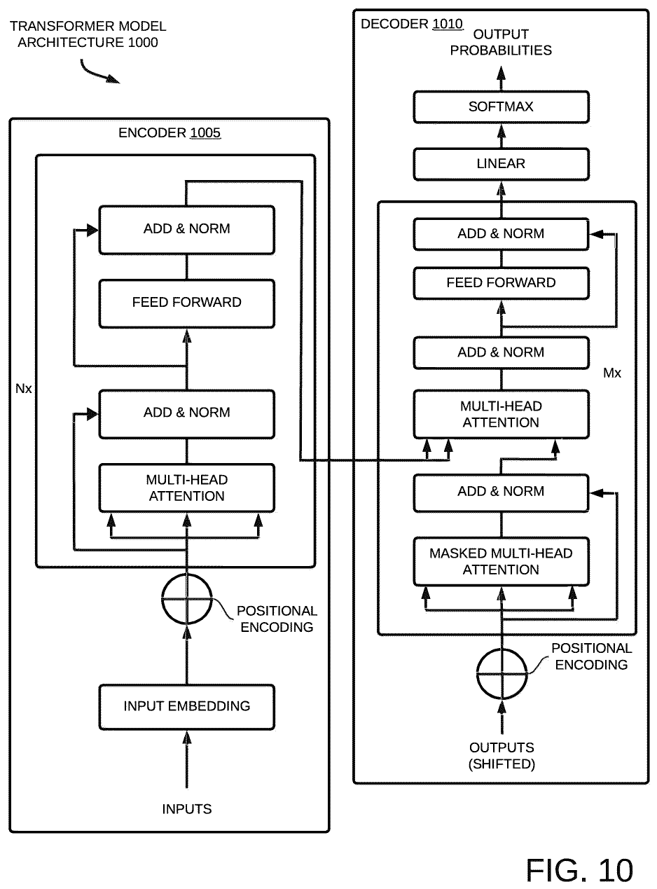

FIG. 10 illustrates an example transformer model architecture 1000 that may be used in the implementation of an LLM according to an embodiment of the present disclosure.

The transformer model architecture 1000 may be a neural network design for natural language processing. At its core, the transformer 1000 may encompass an encoder 1005 and a decoder 1010, both leveraging self-attention mechanisms. The architecture 1000 may begin with an input embedding layer that converts tokens into high-dimensional vector representations that may range, for example, from 128 to 1024 dimensions. These embeddings may be augmented with positional encodings to retain sequence order information.

The transformer model architecture 1000's input embedding layer serves as the initial processing stage for converting discrete tokens into continuous vector representations. These dense embeddings may occupy a high-dimensional space, with dimensionality configurations ranging from 128 to 1024, allowing for rich semantic representation of input tokens. The embedding process maps a token to a unique vector that captures the token's semantic properties in the continuous space. Positional encodings are subsequently added to these token embeddings through element-wise addition, introducing position-dependent signals that encode sequential information. These positional encodings can be implemented using sinusoidal functions or learned parameters, enabling the model to differentiate between tokens based on their positions in the sequence. The combined embeddings preserve both semantic content and sequential order, forming a foundation for the subsequent self-attention mechanisms. This embedding strategy addresses the inherent limitation of transformer architectures in processing sequential data, as the self-attention mechanism alone is position-agnostic.

The transformer 1000 may include a multi-head, self-attention mechanism. This may allow the model 1000 to simultaneously attend to different parts of the input sequence, capturing various types of relationships and dependencies. An attention head may compute query, key, and value vectors, enabling the model to focus on relevant parts of the input when processing a token. Following the attention layers, the architecture 1000 may incorporate feed-forward neural networks with multiple layers and non-linear activation functions.

The multi-head self-attention mechanism forms a component of the transformer architecture 1000, enabling parallel processing of input sequence elements. An attention head operates as an independent attention mechanism, computing three distinct matrices: queries (Q), keys (K), and values (V) through learned linear transformations of the input embeddings. The parallel nature of multiple attention heads allows the model to capture diverse relationship patterns within the same input sequence simultaneously, such as syntactic dependencies, semantic relationships, and long-range contextual connections. The attention computation follows the scaled dot-product attention formula, where the dot product between queries and keys determines alignment scores, followed by scaling and softmax normalization to produce attention weights. These weights are then applied to the value vectors, creating context-aware representations. The feed-forward neural networks following the attention layers include two linear transformations with a non-linear activation function (e.g., ReLU or GELU) between them, processing a position's output independently. This combination of self-attention and position-wise feed-forward networks enables the model to alternate between gathering contextual information across the sequence and applying complex transformations to individual positions, creating a powerful mechanism for sequence processing.

A masked, multi-head attention mechanism in the decoder 1010 of a transformer model 1000 may be designed to prevent the model from attending to future tokens during sequence generation. In this mechanism, multiple attention heads may operate in parallel, a computing query (Q), key (K), and value (V) matrices from the input embeddings. The attention scores may be calculated as the dot product of Q and K, scaled by the inverse square root of the dimension of the keys. A lower triangular mask may be applied to these attention scores before softmax normalization, effectively setting the upper triangular elements to negative infinity. This masking may ensure that a position can attend to previous positions in the sequence, maintaining the autoregressive property of the decoder. The masked attention scores may then be used to compute a weighted sum of the value vectors. The outputs from the heads may be concatenated and linearly transformed to produce the attention output. This process may allow the decoder to generate tokens sequentially while considering the previously generated tokens, thus preserving the causal nature of language modeling.

The masked multi-head attention mechanism in the transformer's decoder 1010 implements causal masking to enforce autoregressive generation during sequence processing. An attention head performs linear projections to create query (Q), key (K), and value (V) matrices from input embeddings through learned weight matrices WQ, WK, and WV respectively. The attention computation follows the formula Attention (Q, K, V)=softmax (QK^{T}/\sqrt{dk}) V, where dk represents the dimensionality of the key vectors. A lower triangular mask matrix gets added to the attention scores before softmax normalization. This mask sets all upper triangular elements to negative infinity (−0), effectively zeroing out these positions after the softmax operation. The masking operation ensures strict causality by preventing any position from attending to future positions in the sequence during both training and inference. Following the masked attention computation, the outputs from multiple attention heads are concatenated along the feature dimension and projected through a final linear transformation WO to produce the layer's output. This output maintains the temporal causality required for autoregressive generation while still allowing a position to attend to all previous positions in the sequence. The parallelized implementation of multiple attention heads enables the model to capture various aspects of the sequence history simultaneously, while the masking mechanism maintains the sequential nature of language generation.

To maintain stable training and mitigate vanishing gradients, the transformer 1000 may employ layer normalization after a sub-layer (self-attention and feed-forward networks) and may introduce residual connections. These residual connections may allow unimpeded information flow through the network. The model may include multiple (Nx) encoder and decoder (Mx) layers stacked on top of each other, increasing its capacity to learn complex language patterns.

The transformer architecture incorporates stabilization techniques through layer normalization and residual connections. Layer normalization is applied after both the self-attention and feed-forward network sub-layers, normalizing the activations across the feature dimension for a token position. The normalization process computes the mean and variance of the features, then scales and shifts the normalized values using learned parameters gamma and beta, effectively standardizing the feature distributions throughout the network. Residual connections, implemented as skip connections, add the input of a sub-layer to the transformed output, creating direct paths for gradient flow during backpropagation. The combination of these components follows the formula LayerNorm(x+Sublayer(x)), where x represents the input and Sublayer represents either the self-attention or feed-forward network.

The stacking of multiple encoder and decoder layers increases the model's capacity logarithmically with respect to sequence length, enabling the capture of hierarchical patterns in language. An additional layer in the stack provides an opportunity for more abstract feature representation, with lower layers capturing local patterns and higher layers learning more complex, global dependencies. The interaction between layer normalization and residual connections creates a well-conditioned optimization landscape, facilitating stable training of deep transformer networks while mitigating the vanishing gradient problem that commonly affects deep neural architectures.

The output layer may involve a linear transformation followed by a softmax function, producing probability distributions over the vocabulary for text generation tasks. This architecture 1000's design may allow for efficient parallel processing of input sequences, making it particularly suitable for handling the extensive datasets used in training LLMs.

The output layer of the transformer architecture implements a vocabulary-sized classification mechanism through a linear transformation followed by softmax activation. The linear transformation projects the decoder's hidden states onto a vocabulary-sized space using a weight matrix W∈R\hat{ }(d_model×|V|), where d_model represents the model's hidden dimension and |V| represents the vocabulary size. The subsequent softmax function normalizes these logits into a proper probability distribution across the entire vocabulary, computingP(token_i)=exp(z_i)/Σ_j exp(z_j), where z_i represents the logit for the i-th vocabulary token. This architectural design enables efficient batch processing of input sequences through matrix multiplications, leveraging modern hardware accelerators like GPUs and TPUs. The parallel computation capability stems from the self-attention mechanism's ability to process all sequence positions simultaneously during the forward pass, requiring O (1) sequential operations compared to the O (n) operations needed in recurrent architectures. The model's parallelization efficiency scales particularly well with increasing sequence lengths, making the architecture advantageous for processing the extensive datasets used in large language model training, that often include billions of tokens across diverse domains and languages.

In one or more embodiments, architectural variations enhance or modify the standard transformer design for LLM implementations. The Sparse Transformer introduces structured sparsity patterns in the attention mechanism, reducing the quadratic memory complexity to linear complexity through fixed attention patterns. This modification enables processing of much longer sequences while maintaining model quality. Reformer architectures employ locality-sensitive hashing for attention computation, approximating full attention while significantly reducing memory requirements. The Performer architecture replaces the attention mechanism with kernel-based formulations using random feature decomposition, achieving linear complexity in both compute and memory.

Alternate positional encoding schemes offer various trade-offs. Rotary positional embeddings (RoPE) inject positional information through rotation matrices applied to token embeddings, providing better relative position modeling. Alibi position embeddings add learned bias terms to attention scores, enabling better extrapolation to sequences longer than those seen during training. Some architectures eliminate explicit positional encodings entirely, instead relying on position-aware linear attention mechanisms.

Architecture modifications also target specific computational bottlenecks. Flash Attention optimizes attention computation through careful management of GPU memory access patterns. Mixture of Experts (MoE) architectures incorporate specialized sub-networks activated based on input patterns, increasing model capacity without proportional computation increases. The GLU (Gated Linear Unit) variants replace standard feed-forward networks with gated mechanisms, providing more flexible function approximation. Multi-query attention reduces memory bandwidth requirements by sharing key and value projections across attention heads while maintaining separate query projections.

Some architectures focus on improved training dynamics. DeepNorm modifies the layer normalization scheme to enable stable training of deeper networks. Gradient checkpointing strategies reduce memory requirements during training by recomputing certain activations during backpropagation. State space models offer an alternative to attention mechanisms entirely, using linear state space equations to model sequence relationships with improved computational efficiency.

Alternative architectures for LLM implementation encompass distinct paradigms beyond transformers. Recurrent Neural Networks (RNNs), particularly variants like Long Short-Term Memory (LSTM) networks and Gated Recurrent Units (GRUs), process sequences sequentially through hidden state updates. These architectures maintain explicit temporal dependencies through gating mechanisms, controlling information flow between timesteps. LSTM networks employ three gates-input, forget, and output-along with a memory cell to regulate information persistence. GRUs simplify this structure with reset and update gates while maintaining comparable performance.

Convolutional Neural Networks (CNNs) offer another approach through hierarchical feature extraction. Temporal Convolutional Networks (TCNs) apply dilated convolutions to capture long-range dependencies while maintaining autoregressive properties. The hierarchical structure of TCNs enables parallel processing within a layer while preserving causal relationships. Quasi-Recurrent Neural Networks (QRNNs) combine convolutional and recurrent approaches, using convolution for parallel feature extraction followed by a lightweight recurrent pooling mechanism.

Memory-augmented architectures present another paradigm. Neural Turing Machines (NTMs) and Differentiable Neural Computers (DNCs) supplement neural processing with external memory arrays, accessed through attention-like mechanisms. These architectures separate computation from memory storage, enabling more explicit modeling of long-term dependencies. Memory Networks similarly incorporate dedicated memory components but with more structured addressing mechanisms.

Continuous-time models offer an alternative perspective on sequence processing. Neural Ordinary Differential Equations (Neural ODEs) model sequence evolution as a continuous-time dynamical system, solving differential equations to process inputs. This approach enables variable timestep processing and potentially more natural handling of temporal relationships. Similarly, Neural Controlled Differential Equations (Neural CDEs) extend this framework to handle irregular time series data while maintaining end-to-end differentiability.

Graph Neural Networks (GNNs) provide yet another alternative by modeling sequences as structured graphs. This approach enables explicit modeling of hierarchical relationships and long-range dependencies through message passing between nodes. Graph-based architectures can capture complex dependencies that may be difficult to model with purely sequential approaches, though these architectures may require careful design of graph structure and update rules.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to a request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, a tenant is associated with a tenant ID. An network resource of the multi-tenant computer network is tagged with a tenant ID. A tenant is permitted access to a particular network resource if the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, a database implemented by a multi-tenant computer network may be tagged with a tenant ID. Only a tenant associated with the corresponding tenant ID may access data of a particular database. As another example, a entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates that tenants have authorization to access that applications. For a application, a list of tenant IDs of tenants authorized to access the application is stored. A tenant is permitted access to a particular application if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

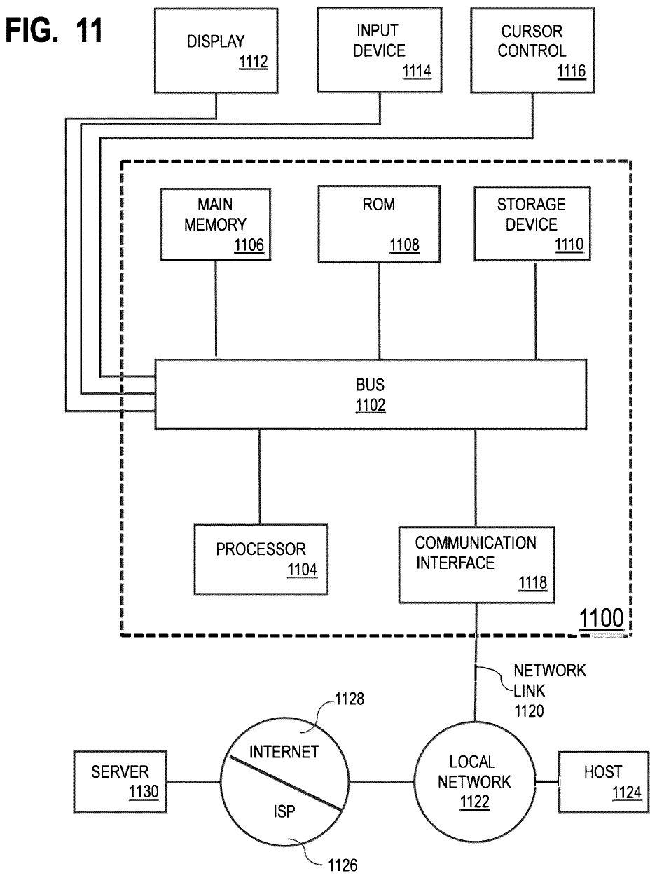

For example, FIG. 11 is a block diagram that illustrates a computer system 1100 upon that an embodiment of the disclosure may be implemented. Computer system 1100 includes a bus 1102 or other communication mechanism for communicating information, and a hardware processor 1104 coupled with bus 1102 for processing information. Hardware processor 1104 may be, for example, a general-purpose microprocessor.

Computer system 1100 also includes a main memory 1106, such as a random-access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk, optical disk, or a Solid-State Drive (SSD) is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic that in combination with the computer system causes or programs computer system 1100 to be a special-purpose machine. According to one embodiment, the techniques herein are performed by computer system 1100 based on processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from that processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the worldwide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, that carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

### 8. Miscellaneous; Extensions

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in that such claims issue, including any subsequent correction.

What is claimed is:

1. One or more non-transitory computer-readable media storing a set of instructions that, when executed by a set of one or more processors, cause a set of one or more computer systems to perform a set of operations comprising:
receiving a set of query-answer pairs of a generative artificial intelligence (AI) chatbot conversation;
determining an alignment score for a first query-answer pair using an alignment analysis model applied to the first query-answer pair;
determining an alignment score for a second query-answer pair using an alignment analysis model applied to the second query-answer pair;
determining a sentiment score for the second query-answer pair using a sentiment analysis model applied to the second query-answer pair;
determining a contextual sentiment score for the set of query-answer pairs;
determining a sentiment and alignment deviation composite score for a portion of the generative AI chatbot conversation comprising the first query-answer pair and the second query-answer pair; wherein the sentiment and alignment deviation composite score for the portion of the generative AI chatbot conversation is calculated based on at least the alignment score for the first query-answer pair, the sentiment score for the second query-answer pair, the contextual sentiment score for the set of query-answer pairs, and the alignment score for the second query-answer pair;
based on at least the sentiment and alignment deviation composite score for the portion of the generative AI chatbot conversation, generating a training example based on at least the second query-answer pair; and
updating parameters of a target machine learning model based on at least the training example.

2. The one or more non-transitory computer-readable media of claim 1, the set of operations further comprising:
determining a sentiment score for the first query-answer pair using the sentiment analysis model;
applying different weights to the sentiment score for the first query-answer pair and the sentiment score for the second query-answer pair based on their temporal positions in the generative AI chatbot conversation;
determining a contextual contrast score for the generative AI chatbot conversation based on at least the sentiment score for the first query-answer pair and the sentiment score for the second query-answer pair as differently weighted;
generating a pseudo-label for the generative AI chatbot conversation based on the contextual contrast score for the generative AI chatbot conversation; and
wherein a higher weight is applied to the sentiment score for the second query-answer pair based on the second query-answer pair being more recent than the first query-answer pair in the generative AI chatbot conversation.

3. The one or more non-transitory computer-readable media of claim 1, the set of operations further comprising:
determining a hard label selected from a set comprising: a negative label, a neutral label, and a positive label, wherein determining the hard label is based on determining a minimum of: (a) the sentiment score for the second query-answer pair and (b) the contextual sentiment score for the set of query-answer pairs;
determining the sentiment and alignment deviation composite score for the portion of the generative AI chatbot conversation based on at least the hard label; and
wherein the negative label corresponds to −1, the neutral label corresponds to 0, and the positive label corresponds to +1.

4. The one or more non-transitory computer-readable media of claim 1, the set of operations further comprising:
determining a complexity level of a query in the second query-answer pair;
evaluating, based on the complexity level, an expected level of detail for an answer corresponding to the query; and
determining the alignment score for the second query-answer pair based on at least comparing a level of detail in the answer to the expected level of detail.

5. The one or more non-transitory computer-readable media of claim 1, wherein determining the sentiment and alignment deviation composite score is based on:
determining a first deviation value as an absolute difference between the alignment score for the first query-answer pair and the alignment score for the second query-answer pair;
determining a sentiment label for the second query-answer pair based on the sentiment score for the second query-answer pair; and
multiplying the first deviation value by the sentiment label to generate the sentiment and alignment deviation composite score; and
wherein a negative sentiment label corresponds to −1, a neutral sentiment label corresponds to 0, and a positive sentiment label corresponds to +1.

6. The one or more non-transitory computer-readable media of claim 1, the set of operations further comprising:
identifying a set of retrieval-augmented generation (RAG) documents associated with the second query-answer pair;
extracting topics and key phrases from the RAG documents;
identifying, based on the extracted topics and key phrases, a set of semantically similar documents from a knowledge base;
performing a batch simulation comprising reseeding a query from the second query-answer pair with the set of semantically similar documents;
generating alternative responses using the set of semantically similar documents;
determining simulation metrics for the alternative responses, wherein the simulation metrics comprise a simulated sentiment score, a simulated alignment score, and a simulated context score;
comparing the simulation metrics to original metrics of the second query-answer pair;
identifying, based on the comparing, positive example documents that lead to improved simulation metrics, and negative example documents that maintain negative simulation metrics; and
generating the training example based on labeling the positive example documents as positive training samples and labeling the negative example documents as negative training samples.

7. A method comprising:
receiving a set of query-answer pairs of a generative artificial intelligence (AI) chatbot conversation, wherein the set of query-answer pairs comprises a first query-answer pair and a second query-answer pair that follows the first query-answer pair in the generative AI chatbot conversation;
determining an alignment score for the first query-answer pair using an alignment analysis model applied to the first query-answer pair, wherein the alignment score for the first query-answer pair reflects an alignment between an answer of the first query-answer pair and a query of the first query-answer pair;
determining an alignment score for the second query-answer pair using an alignment analysis model applied to the second query-answer pair, wherein the alignment score for the second query-answer pair reflects an alignment between an answer of the second query-answer pair and a query of the second query-answer pair;
determining a sentiment score for the second query-answer pair using a sentiment analysis model applied to the second query-answer pair, wherein the sentiment score for the second query-answer pair reflects a sentiment of the second query-answer pair;
determining a sentiment and alignment deviation composite score for a portion of the generative AI chatbot conversation comprising the first query-answer pair and the second query-answer pair; wherein the sentiment and alignment deviation composite score for the portion of the generative AI chatbot conversation is calculated based on at least the alignment score for the first query-answer pair, the sentiment score for the second query-answer pair, and the alignment score for the second query-answer pair; and wherein the sentiment and alignment deviation composite score reflects a change or a lack of change in a quality of the portion if the generative AI chatbot conversation comprising the first query-answer pair and the second query-answer pair;
based on at least the sentiment and alignment deviation composite score for the portion of the generative AI chatbot conversation, determining generating a training example based on at least the second query-answer pair; and
updating parameters of a target machine learning model based on at least the training example.

8. The method of claim 7, further comprising:
determining a sentiment score for the first query-answer pair using the sentiment analysis model;
applying different weights to the sentiment score for the first query-answer pair and the sentiment score for the second query-answer pair based on their temporal positions in the generative AI chatbot conversation;
determining a contextual contrast score for the generative AI chatbot conversation based on at least the sentiment score for the first query-answer pair and the sentiment score for the second query-answer pair as differently weighted; and
generating a pseudo-label for the generative AI chatbot conversation based on the contextual contrast score for the generative AI chatbot conversation.

9. The method of claim 7, further comprising:
converting the sentiment score for the second query-answer pair to a respective hard label selected from a set comprising: a negative label, a neutral label, and a positive label; and
determining the sentiment and alignment deviation composite score for the portion of the generative AI chatbot conversation based on at least the respective hard label for the sentiment score for the second query-answer pair.

10. The method of claim 7, further comprising:
determining a complexity level of a query in the second query-answer pair;
evaluating, based on the complexity level, an expected level of detail for an answer corresponding to the query; and
determining the alignment score for the second query-answer pair based on at least comparing a level of detail in the answer to the expected level of detail.

11. The method of claim 7, wherein determining the sentiment and alignment deviation composite score is based on:
determining a first deviation value as an absolute difference between the alignment score for the first query-answer pair and the alignment score for the second query-answer pair;
determining a sentiment label for the second query-answer pair based on the sentiment score for the second query-answer pair; and
multiplying the first deviation value by the sentiment label to generate the sentiment and alignment deviation composite score.

12. The method of claim 7, further comprising:
including the portion of the generative AI chatbot conversation in a negative context window based on at least the sentiment and alignment deviation composite score indicating a transition from positive to negative conversation quality; and
isolating the negative context window for generating the training example.

13. The method of claim 7, further comprising:
extracting, from the set of query-answer pairs of the generative AI chatbot conversation, a topic classification using a topic extraction model;
determining, using a chat classification model, a question type classification for a query-answer pair in the set of query-answer pairs; and
storing the topic classification and question type classification as metadata associated with the generative AI chatbot conversation.

14. The method of claim 7, wherein generating the training example comprises:
identifying a set of retrieval-augmented generation (RAG) documents associated with the second query-answer pair;
extracting topics and key phrases from the RAG documents;
identifying, based on the extracted topics and key phrases, a set of semantically similar documents from a knowledge base;
performing a batch simulation comprising reseeding a query from the second query-answer pair with the set of semantically similar documents;
generating alternative responses using the set of semantically similar documents;
determining simulation metrics for the alternative responses, wherein the simulation metrics comprise a simulated sentiment score, a simulated alignment score, and a simulated context score;
comparing the simulation metrics to original metrics of the second query-answer pair;
identifying, based on the comparing, positive example documents that lead to improved simulation metrics, and negative example documents that maintain negative simulation metrics; and
generating the training example based on labeling the positive example documents as positive training samples and labeling the negative example documents as negative training samples.

15. The method of claim 7, wherein the target machine learning model comprises one of:
a document reranker model,
a document embedding model,
a large language model (LLM); or
an aggregator model.

16. A system comprising:
a set of one or more computer systems having one or more hardware processors; and
a set of instructions that, when executed, cause the set of one or more computer systems to perform a set of operations comprising:
receiving a set of query-answer pairs of a generative artificial intelligence (AI) chatbot conversation;
determining an alignment score for a first query-answer pair using an alignment analysis model applied to the first query-answer pair;
determining an alignment score for a second query-answer pair using an alignment analysis model applied to the second query-answer pair;
determining a sentiment score for the second query-answer pair using a sentiment analysis model applied to the second query-answer pair;
determining a sentiment and alignment deviation composite score for a portion of the generative AI chatbot conversation comprising the first query-answer pair and the second query-answer pair; wherein the sentiment and alignment deviation composite score for the portion of the generative AI chatbot conversation is calculated based on at least the alignment score for the first query-answer pair, the sentiment score for the second query-answer pair, and the alignment score for the second query-answer pair;
based on at least the sentiment and alignment deviation composite score for the portion of the generative AI chatbot conversation, generating a training example based on at least the second query-answer pair; and
updating parameters of a target machine learning model based on at least the training example.

17. The system of claim 16, the set of operations further comprising:
determining a sentiment score for the first query-answer pair using the sentiment analysis model;
applying different weights to the sentiment score for the first query-answer pair and the sentiment score for the second query-answer pair based on their temporal positions in the generative AI chatbot conversation;
determining a contextual contrast score for the generative AI chatbot conversation based on at least the sentiment score for the first query-answer pair and the sentiment score for the second query-answer pair as differently weighted;
generating a pseudo-label for the generative AI chatbot conversation based on the contextual contrast score for the generative AI chatbot conversation; and
wherein a higher weight is applied to the sentiment score for the second query-answer pair based on the second query-answer pair being more recent than the first query-answer pair in the generative AI chatbot conversation.

18. The system of claim 16, the set of operations further comprising:
converting the sentiment score for the second query-answer pair to a respective hard label selected from a set comprising: a negative label, a neutral label, and a positive label;
determining the sentiment and alignment deviation composite score for the portion of the generative AI chatbot conversation based on at least the respective hard label for the sentiment score for the second query-answer pair; and
wherein the negative label corresponds to −1, the neutral label corresponds to 0, and the positive label corresponds to +1.

19. The system of claim 16, the set of operations further comprising:
determining a complexity level of a query in the second query-answer pair;
evaluating, based on the complexity level, an expected level of detail for an answer corresponding to the query; and
determining the alignment score for the second query-answer pair based on at least comparing a level of detail in the answer to the expected level of detail.

20. The system of claim 16, wherein determining the sentiment and alignment deviation composite score is based on:
determining a first deviation value as an absolute difference between the alignment score for the first query-answer pair and the alignment score for the second query-answer pair;
determining a sentiment label for the second query-answer pair based on the sentiment score for the second query-answer pair;
multiplying the first deviation value by the sentiment label to generate the sentiment and alignment deviation composite score; and
wherein a negative sentiment label corresponds to −1, a neutral sentiment label corresponds to 0, and a positive sentiment label corresponds to +1.
